(19) United States
(12) Patent Application Publication
(10) Pub. No.: US 2026/0236815 A1
(43) Pub. Date: Aug. 13, 2026

(54) APPARATUS FOR PROVIDING CONTROL SIGNALS FOR CONTROLLING A QUANTUM COMPUTER

(71) Applicants: BASF SE, Ludwigshafen am Rhein (DE); ROBERT BOSCH GMBH, Stuttgart (DE)

(72) Inventors: Thomas ECKL, Renningen (DE); Michael KUEHN, Ludwigshafen am Rhein (DE); Benedikt Matthias SCHOENAUER, Karlsruhe (DE); Peter SCHMITTECKERT, Karlsruhe (DE); Nicolas VOGT, Karlsruhe (DE); Jan-Michael REINER, Karlsruhe (DE); Sebastian ZANKER, Karlsruhe (DE); Michael MARTHALER, Karlsruhe (DE)

(21) Appl. No.: 19/148,222

(22) PCT Filed: Jan. 15, 2024
(86) PCT No.: PCT/EP2024/050767

§ 371 Date: Jul. 15, 2025

(30) Foreign Application Priority Data
Jan. 16, 2023 (EP) 23151666.7

(51) Int. Cl. G06N 10/40; G06N 10/20

(52) U.S. Cl. CPC G06N 10/40; G06N 10/20

(57) ABSTRACT

The invention refers to an apparatus 720 for determining signals for generating a solution of a problem using a quantum computer. A providing unit 721 provides a problem description indicative of a first and second portion of the problem. A determination unit 722 determines a trial state representation based on a variational approach. The trial state representation comprises a first and second part representing the first and second portion, respectively. A translation unit 723 translates the trial state representation into an operation trial state description comprising a) second operations determined based on the second part and b) first operations determined based on the first part. A providing unit 724 provides signals for controlling the quantum computer such that the representation of the trial state representation is prepared. The signals referring to the first operations and signals referring to the second operations are performed by different parts of the quantum computer.

### FIELD OF THE INVENTION

The invention relates to an apparatus, a method and a computer program product for providing control signals for controlling a quantum computer to solve a problem. Further, the invention refers to a system for determining a solution of a problem comprising the apparatus.

### BACKGROUND OF THE INVENTION

Quantum computers are generally a completely new kind of computing system that allows utilizing the special behavior of quantum mechanical systems for performing problem calculations that, under the right circumstances, are not performable by ordinary computers in any reasonable time, or with reasonable resources and energy consumption. Moreover, it has already been shown that quantum computers are especially suitable for solving problems that can be related to the quantum mechanical world, i.e., problems that can be translated into a quantum mechanical description. Such problems relate, for instance, to electronic-structure problems, molecular problems, condensed-matter problems, etc. However, also problems outside of the description of physical quantum mechanical systems can be translated into a quantum mechanical description, for instance, coding and decoding problems, complex analysis problems, optimization problems, etc., are known to be translatable to a quantum mechanical description that can be processed by a quantum computer. Examples for the translation of such problems can generally be found, for example, in the article “Quantum algorithms: an overview.” by Montanaro, A., npj Quantum Inf 2, 15023 (2016). However, today's already existing quantum computers often suffer from an inherent sensitivity to errors due to relaxation and decoherence but also due to imperfections in the controlling of the quantum mechanical systems forming the heart of the quantum computer or due to readout errors. These difficulties with the accuracy of quantum mechanical calculations are directly related to the number of qubits, i.e., quantum mechanical elements comprising at least two states, that are utilized and also to the duration of the quantum mechanical calculation, and further to the amount of qubit operations performed on the quantum mechanical system. Thus, up to now the problems that can be solved on a quantum mechanical computer are often limited by the necessary quantum mechanical calculation efforts. Thus, it would be advantageous, if solutions would be provided that decrease the requirements for the quantum resources of a quantum computer and allow the computation of more sophisticated problems on quantum computers.

### SUMMARY OF THE INVENTION

It is an object of the present invention to provide an apparatus, a system, a method and a computer program product that allow to decrease the requirements for the quantum resources of a quantum computer and thus allow to solve problems with an increased complexity. Moreover, more kinds of problems can be solved on a quantum computer utilizing the present invention. In particular, it becomes possible to solve problems comprising frequency dependent dynamical interactions of quantities of the problem on a quantum computer, like problems derived from perturbation theory applied to a problem, for example, problems derived utilizing constraint random phase approximation (cRPA).

In the first aspect of the present invention, an apparatus for determining control signals for generating a solution of a problem translatable into a quantum mechanical description using a quantum computer is presented, wherein the apparatus comprises i) a problem providing unit for providing a problem description indicative of the problem to be solved, wherein the problem description is indicative of a first portion and a second portion of the problem, wherein the first portion includes quantities describing the problem that interact with each other and the second portion includes quantities describing the problem that do not interact with each other, ii) a trial state determination unit for determining a trial state representation of the problem description based on a variational approach, wherein the trial state representation comprises one or more variational parameters and wherein the trial state representation comprises a first and second part representing the first and second portion of the problem, respectively, iii) a translation unit for translating the trial state representation for specific values of the one or more variational parameters into an operation trial state description comprising a sequence of quantum operations to be applied to quantum representation elements of the quantum computer to prepare a representation of the trial state representation on the quantum computer, wherein the sequence of operations comprises a) second operations determined based on the second part of the trial state representation and b) first operations determined based on the first part of the trial state representation, and iv) a controlling signal providing unit for providing control signals for controlling the application of the determined sequence of quantum operations on the quantum computer such that the representation of the trial state representation is prepared, and further for controlling a readout of the quantum computer to measure, after the application of the sequence of determined quantum operations, at least one observable of the quantum mechanical state of the prepared representation of the trial state representation, wherein the control signals are provided such that control signals referring to the first operations and control signals referring to the second operations are performed by different parts of the quantum computer.

Since a trial state representation comprises a first and a second part representing the first and second portion of the problem and since the translation unit is adapted to translate the trial state representation for specific values of the one or more variational parameters into a representative quantum trial state description comprising a sequence of quantum operations comprising a) second operations determined based on second portions of the problem and b) first operations determined based on first portions of the problem, wherein the control signal providing unit is adapted to provide the control signals for controlling the application of the determined sequence of quantum operations on the quantum computer such that control signals referring to the first operations and control signals referring to the second operations are performed on different parts of the quantum computer, the controlling and also the necessary quantum resources can be adapted specifically to the respective portion of the problem. In particular, the first portion, for instance, referring to fermion-boson interactions or spin-boson interactions can be implemented by utilizing specifically adapted control signals and quantum computational resources. This allows to reduce the general requirements on the quantum mechanical resources, in particular, on the quantum mechanical hardware. Moreover, due to the splitting of the problem into first and second portions that are treated differently, a more efficient control of the quantum mechanical resources of the quantum computer becomes possible, for instance, due to the possibility of implementing the first portion of the problem on components of the quantum mechanical hardware of the quantum computer which are easier to control than the quantum elements. Thus, generally, quantum resources necessary for solving the problem can be decreased allowing for the solution of more sophisticated problems.

Furthermore, since the variational approach is chosen in this context, complicated time evolutions resulting from the coupling of the bosonic modes to the fermionic or spin modes in the first portion of the problem can be avoided by means of the variational optimization approach. For instance, by providing the possibility for introducing optimization parameters that can be adjusted on a classical computer. Thus, the complexity of the quantum mechanical calculation can be reduced allowing for a reduction of necessary quantum computer resources for solving the problem leading directly to an easier and less complex control of the quantum mechanical components of the quantum computer. Since the error rate of a quantum computer is directly related to the computation time and thus to the amount of used quantum computational resources, not only the control becomes more effective, but further the reliability of the results of the quantum mechanical calculation can be improved.

Generally, the apparatus can be realized in form of software or hardware or a combination thereof, wherein the hardware can refer to any known dedicated or general classical computer hardware. For example, the apparatus can be realized as any known computational device, like a PC. However, the apparatus can also be realized as a cloud environment, computational network, etc., such that at least parts of the apparatus can also be realized as a network solution and thus can be spread over a plurality of computational devices. The apparatus is adapted to provide control signals that can be provided to, i.e. are interpretable by, any known quantum computer hardware architecture. However, in a preferred embodiment the quantum computer utilized for the quantum mechanical calculation of the problem for which the apparatus provides the control signals, is specifically modified and dedicated for solving problems comprising a first and a second portion.

The problem to be solved by the quantum computer refers to a problem comprising a first and a second portion, wherein the first portion includes quantities describing the problem that interact with each other and the second portion includes quantities describing the problem that do not interact with each other. In an embodiment, the first portion can consist purely of quantities describing the problem that interact with each other and/or the second portion consist purely of quantities describing the problem that do not interact with each other. Preferably, the problem can be provided in form of or translatable into a quantum mechanical description, wherein in this description it is preferred that the first portion is represented by bosonic fields interacting with fermions or spins and thus describing quantities of the problem that interact with each other and the second portion is represented by fermions or spins not interacting with each other and thus describing the non-interacting quantities of the problem. Preferably, the interaction of the quantities describing the problem of the first portion refers to a dynamical interaction, i.e., a frequency or time dependent interaction of the respective interacting quantities, wherein the interaction can also be a retarded or advanced interaction. Further, the problem can comprise a third portion, wherein the third portion also includes quantities describing the problem that interact with each other, in particular, that interact statically with each other, i.e., interact such that there is no time or frequency dependence in the interaction between the respective interacting quantities. The third portion of the problem is preferably also processed by the second portion operation part of the quantum computer. Thus, in some embodiments the third portion of the problem can be regarded as part of the second portion of the problem that is also processed by the second portion operation part of the quantum computer. If the problem is provided in a quantum mechanical description, the third portion of the problem can refer, for instance, to statically interacting fermions, for instance, to a density-density interaction of the fermions.

The problem providing unit is adapted to provide a problem description indicative of the problem being translatable into a quantum mechanical description indicative of or comprising the first and second portion to be solved, in particular, being indicative of or comprising fermion-boson or spin-boson interactions. In particular, the problem providing unit can refer to a storage unit on which the problem description is already stored. However, the problem providing unit can also comprise an input unit with which, for instance, a user can indicate a problem description of the problem to the problem providing unit. The problem description can refer to any form of description of the problem that allows to determine the quantities describing the problem and the form of interaction between these quantities. Preferably, the problem description refers to a mathematical description of the problem. However, the problem description can also refer to any other unambiguous form of notation of the problem. In a preferred embodiment, the problem description is already provided in form of a quantum mechanical description, wherein a quantum mechanical description represents the problem in terms of quantities following the quantum mechanical rules, i.e. refers to a representation of the problem in the quantum mechanical world. However, the problem description can also be provided in any other form, wherein in this case it is preferred that the providing unit is adapted to translate the provided problem description into a quantum mechanical problem description before providing the problem description to the trial state determination unit. However, this translation can also be omitted, wherein in this case the trial state determination unit and the translation unit are preferably adapted to process the respective form of the problem description accordingly, for instance, by utilizing principles derived from the processing of the problem description in the quantum mechanical description.

The trial state determination unit is adapted to determine a trial state representation of the problem description based on a variational approach. In particular, the trial state representation is optimizable with respect to the one or more variational parameters, wherein the optimized state of the trial state representation is indicative of the solution of the problem. Generally, the variational approach refers to solving a problem using a calculus of variations which refers to finding such functions that provide a solution of the problem when optimized with respect to optimization parameters also referred to as variational parameters. Generally, the trial state representation of the problem description refers to such a function that provides in an optimized state an indication of the solution of the problem, wherein the trial state representation is optimized with respect to one or more variational parameters. The trial state determination unit can be adapted to determine a trial state representation for the respective problem description utilizing any known method in the context of the variational approach. Some exemplary methods and principles with respect to the variational approach and to finding a trial state representation for a given problem description can be found, for instance, in the article “Variational quantum algorithms”, Cerezo, M., et al., Nat Rev Phys 3, 625-644 (2021). Preferably, the variational approach refers to a variational Hamiltonian ansatz or a variational quantum eigensolver. Generally, the trial state determination unit can be adapted to determine the trial state representation by determining a unitary evolution operator that applied to a predetermined initial state of the quantum mechanical system described by the problem generates the trial state representation. The unitary evolution operator can be any operator that transforms a predetermined initial state into the determined trial state representation. This determination of the trial state representation can directly be regarded as a representation of the calculation performed on the quantum computer, wherein in such a calculation a sequence of quantum operations is applied to an initial state of the quantum representation elements of the quantum computer.

The variational parameters are generally abstract parameters that are only defined such that they allow an optimization of the trial state representation. Thus, the variational parameters do not have to refer to specific physical or problem related quantities. Since the to be solved problem comprises a first portion and a second portion, the trial state determination unit is adapted to determine the trial state representation such that it comprises a first part and a second part that represent the first and second portion of the problem, respectively. In particular, also the first part of the trial state representation is preferably translatable into a quantum mechanical description, preferably, referring to a fermion-boson interaction or spin-boson interaction and the second part of the trial state representation is, preferably, translatable into a quantum mechanical description referring to non-interacting fermions or non-interacting spins, respectively. Thus, the general structure of the problem as described above is maintained during the translation into the trial state representation.

The translation unit is adapted to translate the trial state representation for specific values of the one or more variational parameters into a representative operation trial state description. In particular, the translation unit is adapted to determine from the problem description the representative operation trial state description such that it comprises a sequence of operations to be performed by the quantum computer for preparing a representation of the trial state representation on the quantum computer. Generally, the operations are performed by the quantum computer by manipulating the state of the quantum representation elements of the quantum computer. The quantum representation elements refer to the elements of the quantum computer that are utilized for simulating the problem, for instance, the quantum representation elements can refer to quantum elements forming qubits, but also to bosonic fields representing bosonic modes during a calculation of the problem. The translation unit is adapted to translate the trial state representation into the representative operation trial state description such that the sequence of quantum operations comprises a) second operations determined based on the second part of the trial state representation and b) first operations determined based on the first part of the trial state representation. Thus, also during this determination of the sequence of operations the problem is divided into two different parts that can specifically be adapted to be applied to different parts of the quantum computer. Preferably, the first operations are determined such that they can be performed by a first portion operation part of a quantum computer and the second operations are specifically adapted to be performed by a second portion operation part of a specifically modified quantum computer as will be described below. Thus, for preparing the trial state on the quantum computer, the parts of the quantum mechanical description of the trial state representation referring to boson-fermion interactions or boson-spin interactions can be implemented on a first portion operation part of a quantum computer and the parts of the trial state representation referring to non-interacting fermions or spins or optionally to statically interacting fermions or spins can be prepared on the second portion operation part of a quantum computer. Preferably, the translating of the trial state representation for the specific variational parameters into a representative operation trial state representation is based on a Jordan-Wigner or Bravyi-Kitaev transformation. In particular, these transformations are applied to fermionic parts of the trial state representation, wherein for the bosonic or spin parts other known transformations can be utilized. In particular, for spin parts a transformation can be omitted and for the bosonic parts standard binary encoding, Gray encoding and/or unary encoding as described, for instance, in the article “Resource-efficient digital quantum simulation of d-level systems for photonic, vibrational, and spin-s Hamiltonians.”, Sawaya, N. P. D., Menke, T., Kyaw, T. H. et al., npj Quantum Inf 6, 49 (2020), incorporated here by reference, can be utilized if a generally known quantum computer is utilized, in particular, if the bosonic parts are represented by quantum elements of the quantum computer. However, if the utilized quantum computer comprises a first portion operation part specifically adapted for representing bosonic parts, in particular, bosonic elements, a transformation can also be omitted. If the trial state representation is determined by determining a unitary evolution operator and an initial state of the quantum mechanical system described by the problem, the determining of the sequence of operations of the representative operation trial state description can comprise determining operations for preparing a representation of the initial state on the quantum computer and a sequence of operations for applying a representation of the unitary evolution operator to the quantum representation elements in the representative initial state such that a representation of the trial state representation, i.e. a trial state, is prepared on the quantum computer. However, in some cases the initial state can be predetermined such that it is automatically prepared on a quantum computer at the beginning of a calculation. In such a case the sequence of operations can also only comprise the sequence of operations for applying a representation of the unitary evolution operator to the quantum representation elements in the representative initial state such that a representation of the trial state representation, i.e. a trial state, is prepared on the quantum computer.

In case the problem description is not provided in form of a quantum mechanical description, the translation unit is preferably further adapted to translate the problem description accordingly, e.g. to map the problem description to a description of a quantum mechanical system that can generally be simulated by the respective chosen quantum computer, for example, by mapping the problem description to a Hamiltonian of a quantum mechanical system that defines similar relations between and influences on quantities as the problem. Thus, for instance, an optimization problem referring to the field of optimizing production parameters for producing a product, like temperature, pressure, flow velocity, etc., can be translated into a quantum mechanical description representing the problem in the quantum mechanical world of the quantum computer. In such a case, for instance, Ising models can be utilized for the translation. However, if the problem already refers to a quantum mechanical problem, for instance, an electronic-structure problem, this particular step of translating the problem into a quantum mechanical description can be omitted. Generally, the translation unit can be adapted to translate the problem description based on predetermined rules or a predetermined model for specific problem categories or can be adapted to translate the problem description in an interactive process based on user input. In the case of an interactive process the user can, for instance, be provided with a user interface that allows the user to select different problem categories, like, optimization problem, electronic-structure problem, etc. to determine the category of the provided problem and can further select a respective set of rules or model that shall be applied for translating the provided problem. However, also other interaction can be facilitated by a user interface for translating the problem. Moreover, for translating the provided problem, the translation unit can also be adapted to access a storage on which translations for specific problems are already stored, for instance, for problems that have already been solved before, e.g. for different parameters.

The controlling signal providing unit is configured to provide control signals for controlling the performance of the determined sequence of quantum operations on the quantum computer such that the representation of the trial state representation is prepared. In particular, the control signals are provided such that the control signals referring to the first operations and the control signals referring to the second operations are performed by different parts of the quantum computer. Preferably, the different parts of the quantum computer refer to different hardware parts of the quantum computer. The different parts of the quantum computer can be different hardware parts that are controlled by different controlling hardware. However, the different parts can also refer to the same hardware part that is virtually divided into different parts that can be controlled independently. The different parts of the quantum computer can also be parts of the quantum computer that are predefined as different parts of the quantum computer that are to be controlled differently. In an embodiment, the different parts refer to the quantum computer refer to a second portion operation part configured to utilize quantum mechanical states of quantum elements for forming qubits that are manipulable by operations performed on the quantum elements, and a first portion operation part configured to couple bosonic fields to the quantum elements. For example, the control signals referring to the first operations can be performed by a first portion operation part by manipulating a coupling of bosonic fields to quantum elements forming qubits, and, optionally, representations referring to the bosonic fields themselves. The second operations can then be performed by a second portion operation part of a quantum computer by manipulating the states of the quantum elements, i.e. qubits, on the quantum computer.

Preferably, the controlling signal providing unit is configured to generate control signals for controlling the quantum computer, in particular, a manipulation part of a quantum computer configured to manipulate the states of the quantum representation elements, in accordance with the determined sequence of operations. However, if the quantum computer itself already provides a controlling unit that is adapted to control the manipulation part such that the states of the quantum representation elements are manipulated, the controlling signal providing unit of the apparatus can be adapted to provide the controlling signals to the controlling unit of the quantum computer. In this case, for instance, the control signals can simply refer to a representation of the determined sequence of operations that can be interpreted by the controlling unit of the quantum computer to provide the respective control signals for controlling the parts of the quantum computer accordingly. However, the control signals can, in this case, also refer to generally known and interpretable control signals that are translated by the controlling unit of the quantum computer to respective dedicated control signals for controlling the specific hardware of the quantum computer. Thus, the control of the controlling signal providing unit of the apparatus can be directly or indirectly, depending on the respective realization of the quantum computer. The controlling signal providing unit of the apparatus alone or together with an optional controlling unit of the quantum computer can hence be regarded as referring to an interface between the quantum computer, in particular, the hardware of the quantum computer, and the software for solving a respective problem running on a generally known classical computer.

Further, the controlling signal providing unit is adapted for controlling a readout of the quantum computer, in particular, a readout of the state of the quantum representation elements, to measure, after the application of the sequence of determined quantum operations, at least one observable of the quantum mechanical state, in particular, a quantum mechanical state of the quantum representation elements, of the prepared representation of the trial state representation. In particular, the control signals can be adapted to control a readout part of the quantum computer such that the one or more observables are measured, i.e. read out, after the preparation of the trial state representation has been completed. In particular, the controlling signal providing unit can be adapted to receive the readout of the readout part and provide the readout, for instance, to the result determination unit that is part of the classical computational environment. However, as described above, also here the control signal providing unit can interact optionally with a control unit of a quantum computer to act as an interface between the classical computer environment and the quantum computer.

In an embodiment of the invention, the apparatus further comprises an iteration controlling unit for controlling an optimization of the trial state representation utilizing an iteration of the one or more variational parameters of the trial state representation until the at least one readout observable or a quantity derivable from the at least one readout observable converges, wherein the iteration comprises adapting the one or more variational parameters of the trial state representation and repeating the translation, the providing of control signals for preparing the trial state representation and the providing of control signals for the readout until the at least one observable or derivable quantity has converged to at least one final observable or final derivable quantity. The apparatus further comprises a result determination unit for determining, based on the at least one final observable, the solution for the problem.

Generally, an iteration, i.e. iterative procedure, refers to a sequence of repetitions of a process until some predetermined condition is met, wherein in the repetition of the process the outcome of a single iteration step is generally the starting point of the next iteration step. In this embodiment, the iteration refers to varying the variational parameters of the trial state representation until the at least one readout observable or derivable quantity converges, i.e. reaches a predetermined convergence criterion. In some embodiments, the convergence criterion can also refer to a variational parameter that converges during the iteration. In particular, the iteration can refer to a search for a minimum or a maximum value of the one or more readout observable or derivable quantity. The predetermined convergence criterion can then refer, for instance, to a residuum threshold that determines a convergence if a difference between a current readout observable, derivable quantity or variational parameter and a readout observable, derivable quantity or variational parameter determined during the previous iteration step lies below the predetermined residuum threshold. However, if no convergence is reached by the at least one observable, derivable quantity or variational parameter, for instance, due to a failure or error occurring during the iteration, the iteration can also be aborted without reaching convergence, for example, based on an alternative abortion criterion. For example, the abortion criterion can refer to a predetermined number of iteration steps after which it is assumed that no convergence is possible and the iteration is aborted. In this context a derivable quantity refers to a quantity that can be mathematically derived from one or more readout observables. For example, in some embodiments it can be advantageous to use a convergence criterion that refers to a reduced density matrix, for which a value can be determined based on one or more readout observables.

Generally, the iteration is started by providing initial variational parameters as starting point for the iteration, wherein the initial variational parameters can have arbitrary values or can be chosen based on any known iteration optimization process, for instance, can be chosen based on pre-knowledge such that the initial variational parameter values already allow a starting point as near as possible to the convergence point of the at least one readout observable or derivable quantity. The iteration is then started by implementing the initial variational parameters into the trial state representation and utilizing the translation unit and the controlling signal providing unit for providing control signals that allow a preparation of the trial state representation of the initial variational parameters on the quantum computer and a readout of the resulting at least one observable. Based on known iteration algorithms the iteration controlling unit can then be adapted to adapt variational parameters for the next iteration step, for instance, based on the previous iteration parameters and based on the previously measured at least one observable. For example, suitable algorithms for determining variational parameters values for a next iteration step can be a constrained optimization by linear approximation (COBYLA) algorithm or quasi-Newton methods, like a limited-memory Broyden-Fletcher-Goldfarb-Shanno (L-BFGS) algorithm. Generally, also other gradient-based methods like conjugate gradient (CG) algorithms can also be used.

The newly determined variational parameters are then again implemented into the trial state representation and the steps of translating and providing control signals for preparing this trial state representation and for reading out the at least one observable are repeated until the convergence criterion has been met, i.e. the at least one observable converges, or a general abortion criterion is met. Such a general abortion criterion can refer, for instance, to a predetermined number of iteration steps that should not be exceeded or can refer to other quantities that indicate that the iteration has failed, for instance, due to a too high amount of errors or due to a disturbance. However, generally the at least one readout observable will converge after a sensible amount of iteration steps and the at least one readout observable determined for the last iteration step is determined as the at least one final readout observable. The at least one final observable is then, in accordance with the variational approach, indicative of the solution of the problem and the result determination unit is adapted to determine based on the at least one final observable the solution of the problem.

The result determination unit is then adapted to determine based on at least one final observable the solution of the problem. For example, the result determination unit can be adapted to translate the at least one final observable that is indicative of the solution of the representative quantum mechanical description of the problem to the respective solution in the problem description, for example, utilizing the same manner of translation that has been used to translate the problem description into the representative quantum mechanical description. Additionally and/or alternatively, the result determination unit can be adapted to perform further calculations or manipulations based on the at least one final observable to determine the solution of the problem. For example, averaging processes, error correction processes, further optimization processes, etc. can be applied based on the at least one final observable to determine the solution of the problem. Generally, the solution of the problem can then be provided to a user, for instance, via an output unit like a display, or can be further utilized, for example, for directly controlling a production of a product with respective optimize production parameters.

In a preferred embodiment, the at least one measured observable is indicative of the energy of the prepared trial state representation, and the converging of the at least one observable refers to a minimization of the energy. In particular, determining a trial state representation such that a measured observable and thus the observable to be optimized refers to the energy of the prepared trial state representation, wherein the converging of the at least one observable refers to a minimization of the energy, allows, for instance, to solve optimization problems, in particular, quantum mechanical many-body problems that refer to the determination of a ground or an excitation state of a quantum mechanical system, e.g., a quantum mechanical many-body system, electrons in atoms or molecules, spins in solids, etc. However, this approach can also be advantageous for all other problems, in particular, optimization problems, that can be translated into a quantum mechanical description referring to the determination of a ground state or an excitation state of a quantum mechanical system.

In an embodiment, the controlling signal providing unit is adapted to provide control signals for controlling the quantum computer to prepare a predetermined initial state representation on the quantum computer before applying the determined sequence of operations to prepare the trial state representation. Preferably, this state comprises an overlap with the converged solution of the problem or the state fulfils the same symmetries, such as for example the same particle number, as an ideal solution state. Such an initial state can for example be the ground state of a simplified model such as a non-interacting quantum mechanical system or a Hartree-Fock ground state or can be chosen to span a significant part of the computational space. Preparing a first predetermined initial state representation, i.e. a translation to the initial state as a specific state of the quantum representation elements of the quantum computer, makes sure that the preparation of the trial state representation on the quantum computer can always start from the same starting point, i.e. that the preparation of the trial state representation can always be determined based on the knowledge of the initial state. Thus, the controlling can become more effective and the result of the preparation of the trial state representation becomes more accurate. This leads to a more accurate determination of the result of the quantum mechanical calculation and to less iteration steps on the quantum computer to find a solution of the problem. In an embodiment, the initial state refers to the ground state of a mean-field representation of the problem or a Hartree-Fock state of the first part of the problem. Preferably, the initial state refers to the Hartree-Fock reference state of the fermionic parts of the problem for quantum elements, to a mean-field state of the spin parts of the problem for the quantum elements, and to a mean-field state of bosonic parts of the problem for boson elements of a quantum computer, wherein the interaction between these parts is set to zero in the initial state. However, also other initial states can be prepared that might be advantageous for specific problems or trial state preparations.

In a preferred embodiment, the problem description is representable by a quantum mechanical description comprising fermion-fermion interactions, wherein the apparatus further comprises a transformation unit adapted to transform the problem description into a problem description representable by a quantum mechanical description comprising boson-fermion interactions as first portion of the problem and non-interacting fermions as second portion of the problem. Moreover, the representation of the non-interacting bosonic fields can be regarded as also being part of the first portion of the problem. Generally, the transformation is preferably adapted to transform fermion-fermion interactions of the quantum mechanical description of the problem into fermion-boson interactions defining a connection between the fermion-fermion interaction, the bosonic field resonance frequencies and the fermion-bosonic field coupling strength. Optionally, the transformed quantum mechanical description can further comprise statically interacting fermions as third portion. For example, the problem description can directly be provided as a quantum mechanical description relating to a fermion-fermion interaction problem or, the problem description can generally be represented in a quantum mechanical description that relates to a fermion-fermion interaction problem. Preferably, before the transformation unit transforms the problem, the transformation unit is adapted to translate the problem description into the quantum mechanical description such that the transformation unit can be adapted to utilize for transforming the problem according to respective quantum mechanical rules and algorithms. However, the transformation unit can also be adapted to transform the problem description in any other form or notation that unambiguously describes the problem, wherein in this case the respective utilized transformation can be based on rules that have been deduced from the quantum mechanical transformation of the problem in the quantum mechanical description. In a preferred embodiment the transformation unit is adapted to transform the problem description referring to a quantum mechanical description comprising fermion-fermion interactions by utilizing a Hubbard-Stratonovich transformation. However, also other known transformation algorithms can be utilized.

In an embodiment, the problem description comprises at least portions that are representable by a quantum mechanical description comprising a static fermion-fermion interaction as third portion of the problem and wherein the transformation unit is adapted to approximate these portions of the problem by utilizing a constrained random phase approximation (CRPA). This allows to reduce the number of fermionic states that have to be simulated during the quantum mechanical calculation of the problem and thus also the number of operations and the number of quantum elements used in the calculation. Thus, even more complex and larger problems, i.e. problems represented by a larger number of fermionic states, can be calculated on the quantum computer. Generally, a cRPA allows to differentiate between fermions that take an active part in the problem solution and fermions that can be considered as general background to the fermions that take an active part. For example, if reactions between different molecules shall be simulated in the problem, only the electrons in the outer orbitals, i.e. the valence orbitals, can be considered as taking an active part in the problem solution, whereas electrons in the inner orbitals of the atom can be considered as providing only a background for the electrons in the outer orbitals. Another example are transition metal oxide materials, where only the narrow d-states close to the Fermi energy take part in the active part of the calculation, whereas the other electronic states are considered as effective screening background by cRPA. Applying a constrained random phase approximation allows in such a context to describe the background fermions, instead of individuals, as a charge cloud that interacts with the active fermions, in particular, provides a screening effect for the active fermions.

In an embodiment, the problem description refers to a quantum mechanical description and the translation unit is adapted to translate the quantum mechanical description of the problem into a rotating reference frame, in particular, by applying a rotating wave approximation, before the translation into the representative operation description. Preferably, the translation unit is adapted to further apply the rotating wave approximation to the quantum mechanical description in the rotating reference frame. Utilizing the rotating reference frame and the rotating wave approximation for the quantum mechanical description allows for a simplification of different time scales resulting from different parts of the hardware acting on these different time scales. For example, a second portion operation part, as defined below, can act on a different time scale as a first portion operation part, as defined below, depending on an actual realization of the quantum computer. The rotating reference frame and the rotating wave approximation allow for a much easier synchronization of these different time scales during the quantum mechanical calculation of the problem.

In a further aspect of the invention, a system for processing a problem is presented, wherein the problem comprises a first portion and a second portion, wherein the first portion includes quantities describing the problem that interact with each other and the second portion includes quantities describing the problem that do not interact with each other, wherein the system comprises i) an apparatus as described above for providing control signals for controlling a quantum computer, and ii) a quantum computer adapted to process the provided control signals for performing the quantum mechanical calculation. Preferably, the first portion is translatable into a quantum mechanical description referring to fermion-boson interactions or spin-boson interactions and the second portion is translatable into a quantum mechanical description referring to non-interacting fermions or non-interacting spins, respectively.

In a preferred embodiment, the quantum computer comprises i) a second portion operation part configured to utilize quantum mechanical states of quantum elements for forming qubits that are manipulable by operations performed on the quantum elements, wherein the operations are related to the second portion of the problem ii) a first portion operation part configured to couple bosonic fields to the quantum elements, wherein the coupling of the bosonic fields to the quantum elements is manipulable by operations that are related to the first portion of the problem, iii) a manipulation part configured to manipulate a) the second portion operation part such that the states of the quantum elements are manipulated based on control signals indicative of operations that are related to the second portion of the problem, and b) the first portion operation part such that the coupling of the bosonic fields to the quantum elements is manipulated based on control signals indicative of operations that are related to the first portion of the problem, and iv) a readout part configured to measure, after the manipulation of the quantum elements and the bosonic coupling for performing the quantum mechanical calculation, at least one observable of the a) quantum mechanical state of each quantum element representing the state of a respective qubit and b) bosonic fields.

Since the quantum computer is configured such that the different portions of the problem can be solved by different parts of the quantum computer, different dedicated parts of the quantum computer allow for a more reliable solution. In particular, since the respective interacting portions of the problem do not have to be simulated on the same parts as the non-interacting quantities of the problem, for instance, do not have to utilize alone the quantum elements for performing the calculations for the interacting portion, the calculation becomes less resource-intensive on the hardware, i.e., less entanglement operations are necessary, which require a high degree of control of a quantum mechanical system.

Moreover, since the readout part is configured to measure not only one observable of the quantum mechanical state of each quantum element representing the state of a respective qubit but also to measure the bosonic fields, in particular, a state of a representation of the bosonic fields in the quantum computer, coupled to the respective quantum elements, additional information on the interacting quantities of the problem can be provided. This provides an additional degree of freedom for solving problems on quantum computers. Moreover, since bosonic fields are generally much easier to implement and provide a simpler control concept in the hardware implementation, the quantum mechanical calculations become less error-prone and thus more reliable. Thus, more sophisticated problems can be solved with an improved accuracy.

Generally, the quantum computer can refer to any known realization of the quantum computer, wherein preferred realizations will be described in the following embodiments. For example, the quantum computer can be based on superconducting elements, quantum dots, neutral atoms in optical lattices, nitrogen-vacancy centers in diamond, Bose-Einstein condensates, trapped ions, etc. Due to the plurality of different possible realizations, also the different parts of the quantum computer can be realized in a plurality of different ways. For example, in a superconducting quantum computer the bosonic field can be represented by electromagnetic resonators, whereas in an ion trap quantum computer the bosonic fields can be represented as vibrational modes of the trapped ions. Preferably, the quantum computer refers to a quantum-gate based quantum computer.

The quantum computer is generally adapted to perform quantum operations based on control signals for determining a solution of a problem. Quantum operations can refer to any operations that are performed directly or indirectly on elements of the quantum computer that realize a quantum mechanical description of the problem i.e. that can be described with respect to the quantum mechanical rules instead of the classical physics. However, although an element of the quantum computer can be utilized to realize the quantum mechanical description of a problem, i.e. can be described with the quantum mechanical rules, the element itself does not necessarily have to refer to a quantum mechanical system, e.g. an atom or ion. For example, although in some embodiments electromagnetic resonators are utilized to represent the bosonic fields in the quantum computer that generally follow the classical physical rules, these resonators can in the context of the quantum computer also be described as quantum mechanical quantities. Preferably, the quantum operations comprise all operations that directly or indirectly can influence the states of quantum elements, i.e., qubits, of the quantum computer. For instance, operations performed on the representations of the bosonic fields will, through the coupling between the bosonic fields and the quantum elements, also influence the quantum elements. Thus, also operations performed on the bosonic field representations can refer to quantum operations. The quantum operations hence can comprise operations directly on the quantum elements and thus on the qubits, on the bosonic fields and also on the coupling between the bosonic fields and the quantum elements.

The control signals on which the operations performed by the quantum computer are based are provided by the apparatus in accordance with the above described embodiments of the apparatus.

The second portion operation part, i.e. fermion or spin operation part, is configured to utilize quantum mechanical states of quantum elements in order to form qubits that are manipulable by operations performed on the quantum elements. Generally, the second portion operation part can refer to any hardware of the quantum computer that allows for the performing of operations on the quantum elements. For example, the second portion operation part can comprise the quantum elements themselves and also the components that can be utilized to perform operations on the quantum elements. However, the second portion operation part can also only refer to the hardware part of the quantum computer that is adapted to perform the operations on the quantum elements. In this context, the second portion operation part is adapted such that operations can be performed on the quantum elements that are related to the second portion of the problem to be solved during the quantum computational calculation of the problem. Thus, the second portion operation part allows to perform operations on the quantum elements that are related to the non-interacting quantities of the problem. For example, if a problem is described in a quantum mechanical description, the second portion operation part is preferably adapted to allow for operations performed on the quantum elements that are related to non-interacting fermions and/or non-interacting spins of the quantum mechanical description of the problem.

In case the problem comprises a third portion referring to a static interaction of quantities describing the problem, wherein in this case the first portion of the problem refers to dynamical interactions of quantities describing the problem, the second portion operation part can also be configured to perform operations on the quantum elements that are related to the third portion of the problem.

The first portion operation part, i.e. boson operation part, is configured to couple bosonic fields to the quantum elements. Generally, the bosonic fields refer to entities that in the quantum mechanical description of the quantum computer system represent bosonic modes. In some realizations of the quantum computer the coupling between the bosonic fields and the quantum elements can refer to a hardware induced coupling between hardware elements representing the bosonic fields and the quantum elements such that the boson elements, i.e., the hardware representations of the bosonic fields, can influence the quantum elements. However, in other realizations of the quantum computer the bosonic fields can be represented by controllable specific states of the quantum elements, for instance, vibrational modes, such that no additional hardware components are necessary for representing the bosonic fields directly. Preferably, the bosonic fields are non-interacting in the quantum mechanical description such that the representations of the bosonic fields can also be configured to be non-interacting. For example, hardware boson elements can be configured to be non-interacting, i.e. do not have to comprise a connection or coupling between each other.

The first portion operation part can generally refer to any hardware component that allows for a coupling of the bosonic fields to the quantum elements, for instance, that allows for performing operations on the quantum elements and/or optionally on the boson elements that lead to a coupling of the bosonic fields with the quantum elements. In this context, it is again noted that the bosonic fields themselves can be realized by hardware elements but can also be realized as specific states of one or more elements of the quantum computer, for instance, of the quantum elements themselves. The first portion operation part can accordingly comprise boson elements that are adapted to represent the bosonic fields during the quantum computational calculation of the problem and further the hardware necessary for coupling the boson elements to the quantum elements and also the hardware elements that allow for a manipulation of the coupling and, preferably, of the boson elements. However, in other embodiments the first portion operation part can also refer only to the hardware that is adapted to allow for the coupling of the bosonic fields to the quantum elements and the hardware parts that generally allow for a manipulation of the coupling. For example, if the quantum computer refers to an ion-trap system quantum computer, the bosonic fields can be represented by vibrational modes of ions forming the quantum elements and the coupling and/or manipulation of the coupling can be provided by control lasers that can provide laser light with a specific wavelength to the trapped ions.

The coupling of the bosonic fields to the quantum elements is manipulable by operations that are related to the first portion of the problem to be solved during the quantum computational calculation of the problem. Thus, in particular the operations relate to the interacting quantities describing the problem, in particular, to dynamically interacting quantities describing the problem. Accordingly, the interacting quantities of the problem are represented in the quantum mechanical computation system as bosonic fields interacting with quantum elements. If the problem is provided in a quantum mechanical description referring to a fermion-boson system as described above, the interacting quantities can be mapped to the interaction between the bosons and fermions. Moreover, if the problem is provided in a quantum mechanical description referring to a spin-boson system, the interacting quantities can be mapped to the interaction between the bosons and spins. This kind of representation of the interacting quantities allows utilizing hardware components that are much easier to handle and manipulate than the quantum elements themselves for representing at least a part of the quantities of the problem. Thus, qubit operations referring to performing operations directly on the quantum elements can be reduced, since qubit operations that otherwise have to represent the interaction between the quantities can be replaced with quantum operations performed on the coupling and/or the bosonic fields. Since the number of qubit operations performed on the quantum elements is related to the accuracy of the solution of the problem, by utilizing the coupled bosonic fields for solving a problem with interacting quantities, the accuracy of the respective result can be improved.

A manipulation part is configured to a) manipulate the states of the quantum elements and b) the coupling of the bosonic fields to the quantum elements. Generally, the manipulation is based on control signals indicative of the operations that are intended to be performed on the quantum elements or the coupling of the bosonic fields. Preferably, the quantum elements are manipulated based on control signals indicative of operations that are related to a second portion of the problem and the coupling of the bosonic fields is manipulated based on control signals indicative of operations that are related to the first portion of a problem. The manipulation part can generally refer to any hardware that is configured to manipulate the respective state of the quantum elements or the coupling of the bosonic fields based on control signals. Thus, the manipulation part can be regarded as referring to an interface between a) software and/or hardware components utilized to provide the control signals and b) the second portion operation part and first portion operation part of the quantum computer realizing the quantum computational calculation. For example, the manipulation part can refer to a controller of the second portion operation part and/or the first portion operation part. In case the quantum computer refers to an ion trap in which the operations on the ions are performed by a laser, the manipulation part can be realized as a controller of the laser.

The readout part is configured to measure, after the performed quantum mechanical calculation, at least one observable of the quantum mechanical state of each quantum element representing the state of a respective qubit and further to measure the bosonic fields, i.e., to measure a state of a representation of the bosonic fields in the quantum mechanical calculation, for instance, a state of a boson element or of the specific state of the quantum elements representing the bosonic fields. Generally, the one or more observables that are measured by the readout part depend on the respective realization of the quantum computer. For example, if the quantum computer refers to an ion trap, the observable measured for the quantum elements can refer to the electronic state of the respective quantum element, whereas the observable for a bosonic field can refer to the respective vibration mode of an ion in the ion trap. However, also depending on the problem the energies of the respective systems can be measured as observables. Generally, the result of the measurement of the respective observables is indicative of the solution of the problem. In particular, depending on the translation of the problem into the quantum mechanical description, the result of the measurement can be utilized during further calculations or can be translated back from the quantum mechanical solution of the respective “real-world” solution of the problem.

In an embodiment, the bosonic coupling of the bosonic fields to the quantum elements is configured to be adaptable to represent a specific coupling of the quantities of the first portion of the problem during the quantum computational calculation, wherein the manipulation part is further configured to adapt the coupling. In this context, the manipulation of a coupling of the bosonic fields to the quantum elements is regarded as referring to the general possibility of providing and controlling such a coupling, for instance, of determining by utilizing quantum operations, which bosonic fields should be coupled to which quantum elements, and the possibility of performing operations on the coupling of the bosonic fields and, optionally, on the bosonic field itself. The adaptation of the coupling of the bosonic fields to the quantum elements refers to the possibility of specifically adapting the effect of bosonic fields on at least one quantum element to which it is coupled, for instance, by performing respective operations or by adapting a hardware setting, for instance, utilizing a switch, prior or during the quantum mechanical calculation. How the effect of the bosonic fields on the quantum elements is determined is generally based on the respective realization of the quantum computer. For example, in case of an ion-trap quantum computer, in which the bosonic fields are represented by vibrational modes of the ions, the effect on the quantum elements represented by the electronic state of the ions can be controlled by controlling the environment of the ions, for instance, by utilizing a laser such that the energy transfer from the vibrational modes to the electronic states can be adapted. However, in other realizations of the quantum computer, the effect of the bosonic fields on the quantum elements to which they are coupled can be controlled in other ways.

In an embodiment, the first portion operation part is configured to couple at least one bosonic field to each quantum element forming a qubit. In a preferred embodiment, the first portion operation part is configured to couple more than one bosonic field to each quantum element forming a qubit, preferably four bosonic fields to each quantum element. It is further preferred that the operation part is configured to couple a bosonic field to only one quantum element forming a qubit. Thus, each quantum element can be coupled to one or more dedicated bosonic fields that are only coupled to one quantum element. This has the advantage that the interaction between the bosonic fields and the quantum element can be controlled more accurately such that unintentional interactions can be avoided. Since unintentional interactions can lead to inaccuracies or errors in the quantum mechanical calculation, this allows to increase the accuracy of the result of the quantum mechanical calculation.

In the following, preferred alternative embodiments of the quantum computer and the respective defined parts of the quantum computer as defined above will be described. In a first preferred alternative, the quantum computer refers to a superconducting quantum computer, in which the quantum elements are realized as superconducting circuits and the coupling of the bosonic fields to the quantum elements by providing electromagnetic resonators that are preferably also based on superconducting technologies, coupled via electromagnetic fields to the superconducting circuits. Preferably, in this embodiment the first portion operation part comprises the resonators as boson elements, wherein the electromagnetic fields of the resonators represent the bosonic fields during a quantum mechanical calculation. In particular, the electromagnetic resonators coupled to the superconducting circuits refer to additional electromagnetic resonators that are specifically provided for representing the bosonic fields. In this context, it is noted that electromagnetic resonators utilized in a superconducting quantum computer for measuring the state of the superconducting quantum elements, i.e. for reading out the qubits, that are regarded as being, for instance, part of the readout unit, can generally not be utilized for representing the bosonic fields. The respective readout operations performed on the readout resonators would destroy the state of the bosonic field represented by the resonator and also the coupling of the bosonic fields to the quantum elements during the readout and thus make the results of the readout unreliable. Accordingly, the electromagnetic resonators that provide the coupling to the superconducting circuits for coupling the bosonic fields to the quantum elements do not refer to electromagnetic resonators utilized for the readout of the superconducting circuits and thus are additional electromagnetic resonators. In this embodiment the boson coupling part can comprise or utilize a microwave source for manipulating electromagnetic fields generated by the resonators and thus for representing the bosonic fields. Moreover, the microwave source can also be used to manipulate a coupling between an electromagnetic field generated by a resonator and the superconducting circuits forming the quantum elements.

In a second alternative preferred embodiment, the quantum computer refers to an ion-trap quantum computer, wherein the quantum elements are realized as ions trapped in an ion trap and the coupling of the bosonic fields to the quantum elements is realized as a coupling of vibrational modes of the trapped ions to electronic states of the trapped ions forming the qubits. In this embodiment, the first portion operation part can comprise or utilize a laser for manipulating the coupling between the electronic states, i.e. modes, of the ions and the vibrational modes. For example, utilizing laser light with respective wavelengths, i.e. frequencies, and amplitudes that are in resonance or close to a resonance of the modes, a coupling can be turned on or turned off or a strength of a coupling can be manipulated. In particular, the coupling of the electronic modes and the vibrational modes refers to the transfer of energy between these modes. Thus, if no coupling is present, substantially no energy is transferred between the modes, whereas, if a coupling is present, the amount of transferred energy determines the strength of the coupling. Preferably, the laser is adapted to be tunable, in particular, the laser can be tuned to a resonance frequency of the quantum mechanical problem description, i.e. a resonance frequency of the quantum elements of the ion-trap. The resonances utilized in this context preferably refer to the carrier transition resonance, the red sideband resonance and the blue side band resonance. The carrier transition resonance refers to a frequency of the transition of a trapped ion between electronic states used in the quantum computer calculation without initiating an energy transfer from or to vibration modes of the ions. The red sideband transition resonance refers to a frequency allowing for a transfer of energy from an electronic state of the ion to a vibration mode of the ion in the ion trap or vice versa. The blue sideband transition resonance refers to a frequency allowing for a simultaneous excitation from a lower energy electronic state of an ion to a higher energy electronic state of the ion and an increase of excitations in the vibration mode or allowing for a simultaneous transition from a higher energy electronic state of an ion to a lower energy electronic state of the ion and a decrease of excitations in the vibration mode so that both can be manipulated at the same time.

In a third alternative preferred embodiment, the quantum computer can refer to any one type of quantum computer and the bosonic coupling is in this case realized by performing additional coupling operations on the quantum elements forming the qubits for representing the bosonic fields and the coupling of the bosonic fields to the quantum elements. In this embodiment, it is preferred that the quantum elements utilized for representing a bosonic field are coupled to each other such that two-qubit operations can be applied and that at least one of the quantum elements representing the respective bosonic field is coupled to a quantum element representing the interacting fermion, i.e. the fermion interacting with the respective bosonic field such that the first portion can be represented. Utilizing such a coupling configuration allows to decrease the control and manipulation requirements on the hardware of the quantum computer compared with, for instance, a full-interacting fermion calculation without bosonic fields. Moreover, the circuit depth for performing the quantum mechanical calculation of the problem can be decreased in this configuration, i.e. the number of quantum operations that have to be applied for simulating the bosonic fields can be decreased compared to a simulation of the problem with other coupling configurations.

In a further aspect of the invention, a method for determining control signals for generating a solution of a problem translatable into a quantum mechanical description using a quantum computer is presented, wherein the method comprises i) providing a problem description indicative of the problem to be solved, wherein the problem description is indicative of a first portion and a second portion of the problem, wherein the first portion includes quantities describing the problem that interact with each other and the second portion includes quantities describing the problem that do not interact with each other, ii) determining a trial state representation of the problem description based on a variational approach, wherein the trial state representation comprises one or more variational parameters, and wherein the trial state representation comprises a first and second part representing the first and second portion of the problem, respectively, iii) translating the trial state representation for specific values of the one or more variational parameters into a representative operation trial state description comprising a sequence of quantum operations to be applied to quantum representation elements of the quantum computer to prepare a representation of the trial state representation on the quantum computer, wherein the sequence of operations comprises a) second operations determined based on the second part of the trial state representation and b) first operations determined based on the first part of the trial state representation, iv) providing control signals for controlling the application of the determined sequence of quantum operations on the quantum computer such that the representation of the trial state representation is prepared, wherein the control signals are provided such that control signals referring to the first operations and control signals referring to the second operations are performed by different parts of the quantum computer, and v) providing control signals for controlling a readout of the quantum computer to measure, after the application of the sequence of determined quantum operations, at least one observable of the quantum mechanical state of the prepared representation of the trial state representation.

In a further aspect of the invention, a computer program product for solving a quantum mechanical problem is presented, wherein the computer program product comprises program code means for causing the apparatus as described above to execute the method as described above.

In a further aspect of the invention, the use of the apparatus as described above, is presented for solving problems referring to electronic-structure problems, spin problems and/or optimization problems.

In a further aspect of the invention the use of the system as described above, is presented for solving problems referring to electronic-structure problems, spin problems and/or optimization problems.

In a further aspect of the invention the use of the computer program product as described above, is presented for solving problems referring to electronic-structure problems, spin problems and/or optimization problems.

The electronic-structure problems can refer, in particular, to molecular problems and condensed-matter problems. Preferably, the molecular problems comprise problems referring to at least one of metal-organic compounds containing transition metals including lanthanides and actinides, chelating agents interacting with metals, catalysts, biomolecules with active centers, macromolecular systems and transition-metal compounds in solution or embedded in an environment. Preferably, the condensed-matter problems comprise problems referring to at least one of transition metal oxides and rare earth elements, e.g., Perovskites, for example, used in solid oxide fuel cells, oxide-based battery cathodes, hard magnets for electric engines, catalysts for fuel cells, transition metal heterostructures for sensors, magnetic-semiconducting sandwich structures for spintronics and high-temperature superconductors.

It shall be understood that the apparatus as described above, the system as described above, the method as described above and the computer program product as described above have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 illustrates a state representation of a qubit as used in quantum computing device,

FIG. 2 illustrates a schematic example of a quantum computing device with qubits as calculation unit,

FIG. 3 illustrates a schematic example method for generating a control signal to perform operations on the quantum computing device and for processing measurement signals from the quantum computing device,

FIG. 4 illustrates a schematic example of a hybrid system including a classical and a quantum computing device,

FIG. 5 illustrates a schematic example of a quantum computing device based on superconductors,

FIG. 6 illustrates a schematic example of a quantum computing device based on trapped ions,

FIG. 7 shows schematically and exemplarily an embodiment of a system for determining a solution of a problem,

FIG. 8 shows schematically and exemplarily a flow chart of a method for determining a solution of a problem, and

FIG. 9 shows schematically and exemplarily an example of a sequence of operations applicable to perform a quantum mechanical calculation.

### DETAILED DESCRIPTION OF THE DRAWINGS

In the following first a short introduction into the general basic principles of quantum computers and the performance of calculations of quantum computers will be provided. Further, general principles can also be found in “Quantum Computation and Quantum Information: 10th Anniversary Edition”, M. A. Nielsen and I. L. Chuang (2010).

Classical computing devices use processors which are based on transistors. The state of each transistor has two controllable states 1 or 0 representing a digital binary or a bit. To perform operations on a classical computing device a human readable program code is translated via a compiler into machine-readable instructions. Machine-readable instructions are control signals, e.g. voltage settings, for each transistor. Representations of the machine-readable instructions may include binary or hexadecimal representations. Based on such machine-readable instructions, the operations are performed on the processor of a classical computing device.

Quantum computation is a relatively new computation method that uses quantum effects, such as superposition and entanglement, to perform certain computations more efficiently than classical digital computers. In contrast to digital computers, which represent information in the form of bits (e.g., “1” or “0”), as described above, quantum computing devices, i.e. quantum computers, use qubits, i.e. quantum bits, to represent information. Quantum computing devices are based on quantum elements adhering to the physics of quantum mechanics, such as superconductors, ions, atoms, quantum dots, photons, particle spins, bosons or the like. These quantum elements may be manipulated in a controlled manner to perform operations.

Although qubits and their manipulation may be described in terms of their mathematical properties, each such qubit may be implemented in a physical quantum element in any of a variety of different ways. Examples of such quantum elements include superconducting materials, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or any medium that exhibits qubit behavior comprising quantum states and transitions there between that can be controllably induced or detected.

Generally, for any given physical quantum element that implements a qubit, any of a variety of properties of that physical unit may be chosen to implement the qubit. For example, if electrons are chosen to implement qubits, then the x, y or z component of an electron spin degree of freedom can be chosen as the property of such electrons to represent the states of such qubits. For any particular degree of freedom, the physical quantum elements can be controllably put in a state of superposition or entanglement and measurements can then be taken in the chosen degree of freedom to obtain readouts of qubit values.

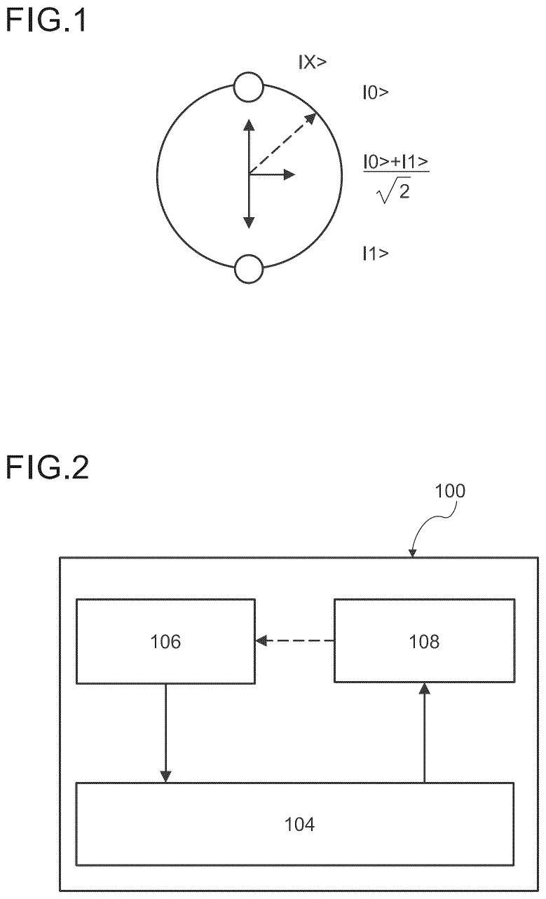

In contrast to transistors of classical computing devices each quantum element of quantum computing devices can not only take the basis states |1 [symbol] or |0 [symbol] but also any superposition of such basis states, such as state |X [symbol] . The state of each quantum element is represented by a state of a quantum bit, i.e. qubit, as illustrated in the two-dimensional simplification of FIG. 1. To represent such states Dirac notation is commonly used in quantum mechanics. In Dirac notation a state in a n dimensional, complex vector space, such as a Hilbert space, is represented in bracket notation, for example |X [symbol] . According to conventional terminology, the superposition of “0” and “1” states in a quantum computing device can be represented as α|0 [symbol] +β|1 [symbol] . The states “0” and “1” or bits of the classical computing device are similar to the basis states |0 [symbol] and |1 [symbol] or quantum bits of the quantum computing device, respectively. The value |α|² represents the probability that the qubit will be measured in the |0 [symbol] state, while the value |β|² represents the probability that the qubit will be measured in the |1 [symbol] state. If more than one qubit is present, two or more qubits may be entangled. Entanglement means that the state of one qubit is dependent on the state of at least one other qubit and vice versa, wherein further in the entangled state the respective qubits cannot be regarded as individual qubits anymore. Generally, a register of N qubits in a quantum computer can be put into a superposition of basis states at once whereas a register of N classical bits can only be in a single basis state at once. Thus, in contrast to classical computing devices on a quantum computing device 2^{N} basis states can be manipulated and processed simultaneously allowing for exponential intrinsic parallelism.

To perform operations on the quantum computing device the computational method to solve a given problem may be translated into qubit operations, which may be translated into control signals for manipulating qubits. Representations of the machine-readable instructions may include common quantum mechanical representations of operations in the Hilbert space. Depending on a specific realization of the quantum computer different representations of the qubit states may be chosen. Any state preparation on the quantum computing device may be represented by an operation acting on the qubit states. An operation may be translated into control signals to control a respective part of the quantum computer, which depend on the type of quantum computing device used. This way based on the operation acting on the qubit states, the operations may be performed on the quantum equivalent of a classical processor as part of the quantum computing device.

The operations acting on the qubit states may generally be one- or multi-qubit operations. A one-qubit operation may change the state of one qubit e.g., into a specific superposition which corresponds to a rotation of the vector |X [symbol] as illustrated in FIG. 1. For example, in a superconducting quantum computer this can be accomplished by microwave pulses or in a trapped-ion quantum computer by irradiation of the ion with a laser beam. A multi-qubit operation may create entanglement between two or more qubits. For example, in a superconducting quantum computer this may be achieved by connecting qubits via an intermediate electrical coupling circuit or in a trapped-ion quantum computer via controlling the collective vibrations of the trapped ions.

Generally, to prepare operations for solving a given problem a respective quantum mechanical representation of the problem may be translated into qubit operations, which are carried out to prepare a solution of the given problem. After the preparation of the predetermined solution, i.e. after the application of the operations to the qubits of the quantum computer, a projective measurement of all individual qubits is carried out returning either 0 or 1 for each qubit. On the quantum computing device this measurement is achieved by applying a hardware-specific readout protocol of a series of readout operations including control pulses and monitoring the response to control pulses. For example, a superconducting qubit may be coupled to a hardware resonator. The measured shift of the resonator frequency allows to determine the state of the qubit as this shift depends on the state of the coupled qubit. In case of trapped ions, for example, an optical readout may be used, e.g. the state of the qubit is 1 if the ion emits light or 0 if the ion does not emit light or vice versa. This way qubits may be used to implement logical circuits or gates as in classical computing devices.

In FIG. 2 a schematic example of a quantum computer is illustrated. The quantum computing device 100 shown in FIG. 2 includes a quantum register 104 configured to perform the quantum computation, a manipulation part 106 configured to manipulate the quantum register, in particular, quantum elements forming the qubits, and a readout part 108 configured to collect measurement signals from the quantum register 104 for reading out the qubits after a quantum mechanical calculation. The manipulation part 106, in particular, provides manipulation signals for manipulating the quantum register, wherein the manipulation signals are generated based on received control signals that are determined based on the respective operations that should be performed on the qubits. In some embodiment a feedback loop between the manipulation part 106 and measurement part 108 can be provided. In contrast to classical computing, where one measurement cycle provides the state of a transistor, quantum computing includes performing multiple measurement cycles to provide a probability density or a probability for the qubit states.

The quantum register 104 can be based on different quantum elements representing the qubits. In some embodiments the qubits may be implemented by photons as quantum elements. Such optical quantum computing devices may include lasers that generate photons that are provided to a waveguide. A beam splitter can be provided for manipulating the photon states based on manipulation signals such as a mechanical rotation applied to a mirror. The measurement part 108 can in such an embodiment be a photon detector, and the measurement signals can be photons.

In other embodiments the qubits can be implemented by electronic states of ions trapped in a magnetic field. The manipulation part 106 can in such a case utilize a laser, and the manipulation signals can cause the providing of control laser pulses. Moreover, in this case, the readout part 108 can be a photon detector combined with read-out laser pulses, and the measurement signals 102 may be photons. Other qubit implementations may be based on superconductors as quantum elements, semiconducting material with anyons as quantum elements, or the like.

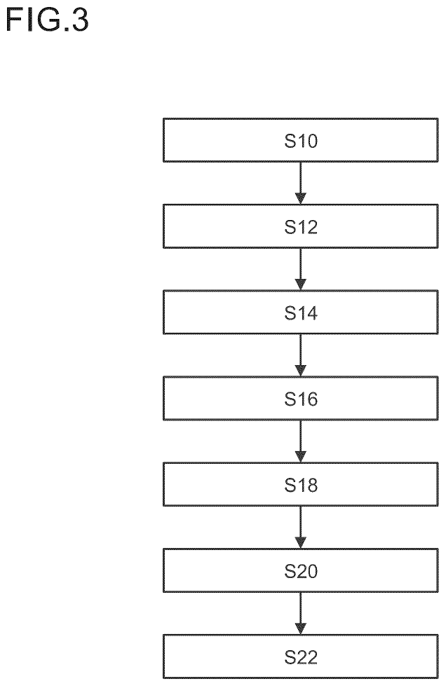

FIG. 3 illustrates a schematic exemplary method for generating a control signal to perform operations on the quantum computing device and for processing measurement signals from the quantum computing device. In most embodiments of quantum computing devices known to date, the control signals for the quantum computing device are prepared on a classical computing device and the measurement signals provided by the quantum computing device are further processed on the classical computing device. Other embodiments are, however, conceivable as quantum computing devices mature.

For generating the control signal to perform operations on the quantum computing device, the problem to be solved with the aid of the quantum computing device is provided in step S10, preferably, in a mathematical description. Such problem may for instance include determining a material property based on the mathematical description of the material's electronic structure. Other problems may include optimization problems and associated objective functions. Based on the problem to be solved, an operation description of the problem or a sub-problem may be generated in step S12, wherein the operation description comprises the operations to be applied to the qubits of the quantum computer to solve the problem in the quantum mechanical calculation. Further, the operation description can include a reference state that allows to generate a representation of an initial qubit state on the quantum computer on which the further operations are then applied by manipulating the qubit states. Based on the operation description control signals can then be generated in step S14 to control the quantum computer, for instance, by providing the control signals to the manipulation unit that can then manipulate the qubit states based on the control signals. In step S16 the manipulation unit then applies the manipulation operations to individual or multiple qubits of the quantum computer, wherein based on the manipulation operations the qubits perform the quantum mechanical calculation. After the manipulation, measurement signals can be generated to determine the result of the quantum mechanical calculation in step S18. This step can include a read-out, i.e. measurement, of the qubit states after applying the manipulation operations to the initial qubit states. The measurement signals can in step S20 then be translated into a measured quantity on the classical computer and in case of a sub-problem fed back into the problem to be solved. Finally, the result of the problem calculation including the quantum mechanical calculation can be provided on the classical computing device in step S22.

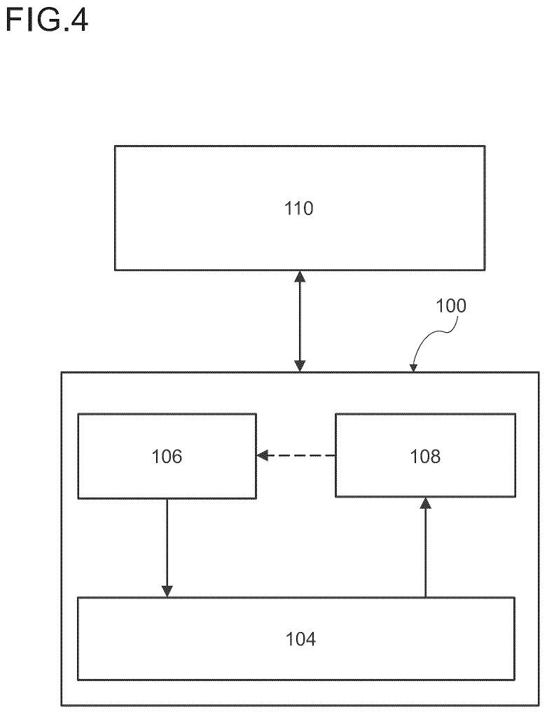

FIG. 4 illustrates a schematic example of a hybrid system including a classical and a quantum computing device. As described with respect to the method illustrated in FIG. 3, quantum computing devices are often used in connection with classical computing devices. As shown in FIG. 4 a problem preparation system can be realized as a classical computing device 110 performing, for instance, steps S10, S12, S20, S22 of the method illustrated in FIG. 3. A controlling unit can then be provided as interface between the classical computing device 110 and the quantum computer 100, wherein the controlling unit can also be a classical computing device, for instance, performing step S14. The control unit can then be communicatively coupled with the manipulation part 106 that can control the manipulators of the quantum computing device. Also, the manipulation part 106 can be realized as a classical computing device, for instance, a classical controlling hardware for the control of specific hardware components of the quantum computer that perform the manipulation of the qubit. However, the manipulation part 106 is generally regarded as part of the quantum computer, since it directly influences the quantum register. The quantum computing device 100 is adapted to perform the quantum operation S16, in particular, by the manipulation of the qubits of the quantum register. The measurement part 108 that is also generally regarded as part of the quantum computing device can then perform the step S18 by utilizing classical hardware. The measurement part 108 can then be communicatively coupled to the preparation system 110 for further processing of the measurement signals.

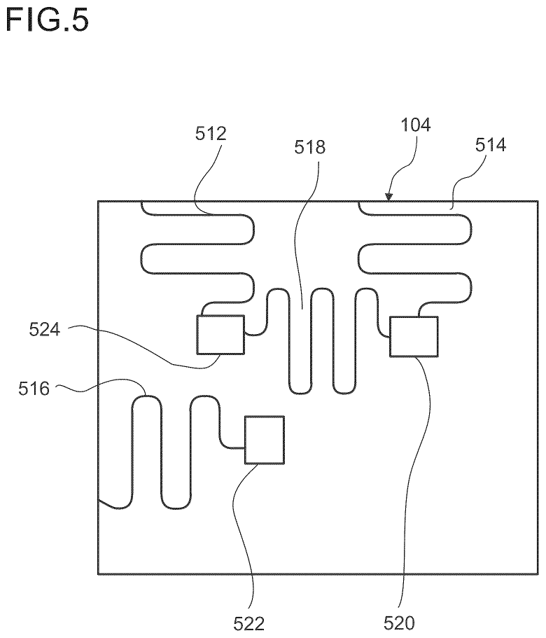

FIG. 5 illustrates a schematic example of a quantum computing device based on superconductors. Superconducting quantum computing devices are one of the solid-state quantum computing technologies. Here the quantum register 104 can include superconducting circuits 520, 522, 524 based on Josephson junctions. The qubits can then, for instance, refer to charge, flux, transmon, or phase qubits depending on the quantity of the superconducting circuits that are chosen to represent the qubits. FIG. 5 refers to a simplified illustration of a superconducting quantum computer utilizing charge qubits. For charge qubits the different states of the qubit are represented by an integer number of Cooper pairs on a superconducting island. Quantum operations can then be performed by manipulating the qubits through microwave pulses. Resonators 512, 514, 516 can be utilized to manipulate the state of the qubits by applying the microwaves or for reading out the state of the qubits by measuring respective microwaves, wherein generally different resonators are used for the manipulation of the state of the qubits and the readout of the qubits. Moreover, resonator 518 can be utilized for applying microwaves that entangle the qubits. However, instead of resonator 518 the entanglement can also be achieved by an inductive or capacitive coupling of the superconducting circuits or even by providing another qubit, here a superconducting circuit, between the to be entangled qubits.

On an operational level such systems are maintained at extremely low temperatures, e.g., in the tens of mK. The extreme cooling of the systems keeps superconducting materials below their critical temperature and helps to avoid unwanted state transitions. To maintain such low temperatures, the quantum information processing systems may be operated within a cryostat, such as a dilution refrigerator. In some implementations, control signals are generated in higher-temperature environments, and are transmitted to the quantum computer using shielded impedance-controlled GHz capable transmission lines, such as coaxial cables. In some implementations, the state measurement of superconducting qubits is achieved using a dispersive detection scheme. In order to read out or detect the state of any qubit, a probing signal, e.g., a travelling microwave, may be excited along a readout transmission line coupled to the qubit via a respective readout resonator. The frequency of the probing signal can be in the vicinity of the resonance frequency of the readout resonator. Depending on the internal quantum mechanical state of the qubit, the intensity or phase of the probing signal transmitted along the readout transmission line may be altered because the reflectivity of the readout resonator coupled to the qubit changes depending on the state of the qubit. This allows for the state detection of the qubits, wherein during the readout of a qubit state the state of the qubit collapses, i.e. is projected with the respective probability onto one of the basis states. By performing the quantum mechanical calculation and the readout a plurality of times the respective probabilities can be determined. Further details for superconducting quantum devices are described e.g. in documents EP 3830867 A1, EP 3449427 A1, US2020272925 A1, CN 212061223 U and US 2019019099 A1.

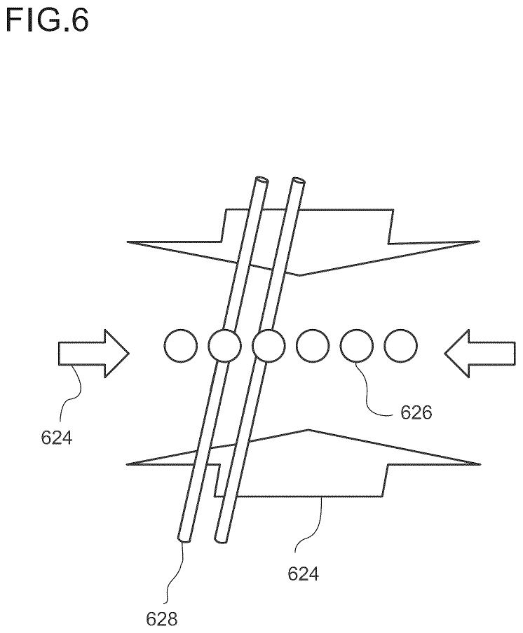

FIG. 6 illustrates a schematic example of a quantum computing device based on ions in an ion trap. Similar to neutral atom traps ion traps with, e.g. positively charged Calcium ions, can be used to implement the quantum computing device. Here ions 626 are trapped in an oscillating electromagnetic field 624 inside a high or ultra-high vacuum. The ions 626 are laser cooled and held in the oscillating electrical field 624. For qubit manipulation such as superposition or entanglement laser light 628 at different frequencies may be used.

Generally, based on the above described quantum computer realizations gate-model type calculations can be performed on a quantum computer hardware architecture. The gatemodel type calculation is based on quantum gates. In contrast to classical gates, there is an infinite number of possible single-qubit quantum gates that can change the state vector of a qubit. Changing the state of a qubit state vector typically is referred to as a single qubit rotation, and may also be referred to herein as a state change or a single-qubit quantum gate operation. A rotation, state change, or single-qubit quantum gate operation can be represented mathematically by a unitary 2×2 matrix with complex elements. A rotation corresponds to a rotation of a qubit state within its Hilbert space, which can be conceptualized as a rotation of a vector on the Bloch sphere, wherein the Bloch sphere is generally known as a geometrical representation of the space of the pure states of a qubit. Multiqubit gates alter the quantum state of a set of qubits. For example, two-qubit gates rotate the state of two qubits as a rotation in the four-dimensional Hilbert space of the two qubits, wherein, as generally known, the Hilbert space is an abstract vector space possessing the structure of an inner product that allows length and angle to be measured. Furthermore, Hilbert spaces are complete, i.e. there are enough limits in the space to allow the techniques of calculus to be used.

In the following the term operation description refers to a representation of a problem that comprises a sequence of quantum operations that should be applied during a quantum mechanical calculation of the problem. The term “quantum operation” can include in the context of this invention all types of quantum gates as described above. Moreover, the term can also include operations performed on components of the quantum computer representing a coupling between the quantum elements forming the qubits and bosonic fields and, optionally, components representing the bosonic fields themselves. These operations then refer to any kind of change of the state of the coupling or bosonic field representing components, for example, a turning of a coupling on and off, or the change of a field frequency, etc. Further, in some applications the quantum operations can also include measurement operations. This allows to implement algorithms using a measurement feedback. For example, in such an algorithm a quantum computer can execute the quantum gates defined by the sequence of quantum operations and then measure only a subset, i.e., fewer than all, of the qubits or other calculation elements, like the bosonic field states, in the quantum computer, and then decide which further quantum operations to execute next based on the outcome of the one or more measurements. In particular, measurement feedback can be useful for performing quantum error correction, but is not limited to use in performing quantum error correction.

In the following embodiments of the present invention are described, wherein some of the embodiments can be adapted to utilize above described generally known quantum computer devices.

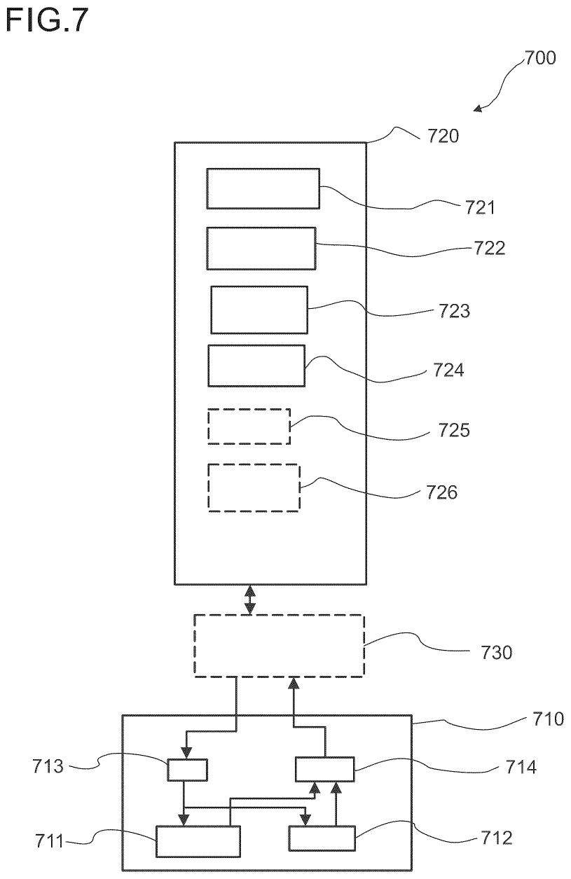

FIG. 7 shows schematically and exemplarily an embodiment of a system 700 for processing a problem, for instance, an electronic-structure problem, in a quantum computational calculation. The system is specifically adapted for solving a problem comprising a first and a second portion, wherein the first portion includes quantities describing the problem that interact with each other and the second portion includes quantities describing the problem that do not interact with each other. Preferably, the problem can be represented in a quantum mechanical description comprising as first portion fermion-boson interactions and optionally the bosonic fields that interact with the fermions but not among themselves and as second portion non-interacting fermions. Moreover, the problem can also comprise a third portion referring to only statically interacting quantities, wherein this third portion can preferably be represented in a quantum mechanical description as static fermion-fermion interactions.

The system comprises a quantum computer 710 and an apparatus 720. Optionally, the system can further comprise a controlling unit 730 as interface between the apparatus 720 and the quantum computer 710. However, an explicit controlling unit 730 can also be omitted or can be, for instance, a dedicated part of the quantum computer 710. The quantum computer 710 of the system can refer to any known quantum computer solution with respect to already known quantum computer architectures as already described above. However, in a preferred embodiment, the quantum computer 710 is dedicated to the calculation of problems involving a first and second portion, in particular, it is preferred that the quantum computer 710 comprises a respective hardware structure that allows for a very effective processing of respective problems. Preferably, the quantum computer refers to a modified quantum computer as described in the following.

The quantum computer 710 comprises preferably a second portion operation part 711 that is configured to utilize quantum mechanical states of quantum elements for forming qubits. For example, the second portion operation part can utilize and optionally also comprise a quantum register as described, for instance, with respect to FIG. 2. Generally, the quantum elements forming the qubits are manipulable by quantum gate operations performed on the quantum elements.

Further, the quantum computer 710 comprises in addition to the second portion operation part 711 and different from the generally known quantum computer as described in FIG. 2, preferably a first portion operation part 712. The first portion operation part 712 is configured to couple bosonic fields to the quantum elements wherein the coupling of the bosonic fields to the quantum elements and optionally also the bosonic fields themselves are manipulable by quantum operations performed on a coupling of the bosonic fields and/or the bosonic fields themselves. Thus, as indicated by the two-sided arrow the second portion operation part 711 and the first portion operation part 712 interact with each other through the coupling of the bosonic fields to the quantum elements that are utilized by the second portion operation part 711. Generally, the bosonic operation part 712 can be realized in a plurality of different ways depending on the construction principle on which the quantum computer 710 is based. For example, if the quantum computer 710 refers to a superconducting quantum computer in which the quantum elements are realized as superconducting circuits, as already explained above, the first portion operation part 712 can be configured to utilize and, optionally, comprise, additional resonators, i.e. resonators that are not used for the readout or entanglement of the quantum elements, as bosonic elements representing the bosonic fields, wherein the resonators are coupled to the quantum elements for providing the coupling of the bosonic fields to the quantum elements. Thus, in such an exemplary embodiment the bosonic fields will be represented by the electromagnetic fields provided by the resonators and the coupling will be represented by the interaction of the respective electromagnetic fields with the superconducting circuits forming the quantum elements. A more detailed description of this embodiment and also further exemplary embodiments of a realization of the first portion operation part will be discussed with respect to the more detailed embodiments of the present invention.

Preferably, the second portion operation part 711 is adapted to allow for a manipulation of the quantum elements by operations that are related to the second portion of the problem, that includes quantities describing the problem that do not interact with each other. In contrast thereto the first portion operation part 712 is specifically configured to allow for manipulations by operations that are related to the first portion of the problem that refers to quantities describing the problem that interact with each other. Thus, by structuring the quantum computer 710, preferably, in contrast to the quantum computer as described in FIG. 2, to provide a second portion operation part 711 and additionally a first portion operation part 712 it becomes possible to transfer the representation, i.e. simulation, of interacting quantities of the problem to an interaction of different parts of the quantum computer 710, for instance, to an interaction of additional resonators with superconducting circuits, that can be controlled independently. Moreover, it becomes possible that the first portion operation part 712 due to the decoupling of the two portions of the problem is represented by systems that are constructed to be controlled in a technically different manner than the quantum elements allowing to decrease the number of quantum gate operations that have to be performed explicitly on the qubits for solving a given problem. Thus, not only can a better control be provided that allows for an increase in the accuracy of the calculation, but further the necessary qubit resources can be decreased allowing for the calculation of more complex problems on given qubit resources.

Further, the quantum computer 710 comprises preferably a manipulation part 713 that is configured to manipulate a) the second portion operation part 711 and b) the first portion operation part 712. In particular, the manipulation part 713 is configured to manipulate the second portion operation part 711 such that the states of the quantum elements are manipulated based on control signals that are in particular indicative of operations that are related to the second portion of the problem, as described above. Moreover, the manipulation part 713 is configured to manipulate the first portion operation part 712 such that the coupling of the bosonic fields and, optionally, also the bosonic fields themselves are manipulated based on control signals that are indicative of operations that are related to the first portion of the problem as described above. For example, the manipulation unit 713 can be regarded as a controller of a laser that can be regarded as being part of the second portion operation part 712 and that allows to manipulate the quantum elements, i.e. qubits, in quantum computers that are realized as ion traps. Alternatively, the manipulation 713 part can refer to a controller of a microwave source that is utilized to manipulate the qubits and/or the bosonic fields in a quantum computer that is realized as a superconducting quantum computer. Thus, the manipulation part 713 is provided with control signals, for instance, of the control unit 730 that are indicative of the operations that should be performed by the second portion operation part 711 and the first portion operation part 712 and utilizes these control signals for controlling the respective part of the quantum computer accordingly.

Further, the quantum computer 710 comprises preferably a readout part 714 that is configured to readout the quantum elements utilized by the second portion operation part 711 and the bosonic fields utilized by the first portion operation part 712. Generally, the readout of the quantum elements and of the bosonic fields refers to measuring at least one observable of the quantum mechanical state of each quantum element utilized by the second portion operation part 711 and to measuring a state of a representation of the bosonic fields utilized by the first portion operation part 712. The measurement of the bosonic fields, for instance, can refer to measuring an observable or signal provided by bosonic elements representing the bosonic fields. For example, if the quantum computer is a superconducting computer in which the bosonic fields are represented as resonators, the readout unit can be adapted to measure the electromagnetic field provided by the resonators or changes in this electromagnetic field. Alternatively, if the quantum computer refers to an ion trap quantum computer in which the bosonic fields are represented by vibrational modes of the trapped ions, the measurement unit can be adapted to measure a frequency of the vibrational modes of the trapped ions. The result of the measurement of the readout unit 714 is then indicative of the solution of the calculated problem.

Optionally, the functioning of the quantum computer 710 can be controlled by a controlling unit 730. The controlling unit 730 is adapted to provide control signals to the manipulation part 713 that are indicative of the desired operations to be performed by the second portion operation part 711 and the first portion operation part 712, wherein the manipulation part 713 then performs the respective manipulation, for instance, by controlling the laser or microwave source of the second portion operation part 711 or first portion operation part 712, respectively. Moreover, the controlling unit 730 can also be adapted to control the readout unit 714 to readout after the performance of the operations the respective result of the quantum mechanical calculation. In particular, the readout part 714 can then be adapted to provide a signal indicative of the measured result to the controlling unit 730. Thus, optionally the controlling unit 730 can be part of the quantum computer 710. For instance, the controlling unit 730 can be realized as software and/or hardware together with the manipulation part 713, for example, as part of a laser or microwave source controller. However, the controlling unit 730 can also be separate from the manipulation unit 713 and be provided in form of a separate software and/or hardware for controlling the quantum computer 710.

If a controlling unit 730 is provided, for instance, as part of the quantum computer 710, it is preferred that the controlling unit 730 receives control signals from apparatus 720. The controlling unit 730 can then generate the control signals for controlling the manipulation part 713 based on the control signals received from the apparatus 720. For example, the controlling unit 730 can translate the control signals received from the apparatus 720 into control signals that can be understood by the specific hardware and/or software of the specific manipulation part 713 of the quantum computer 710. Such a translation can be useful if the control signals provided by the apparatus 720 are in a different format or follow a different protocol than the control signals used for controlling the manipulation unit 713. However, the control signals provided by the apparatus 720 can also already be in the correct format or protocol such that a translation is not necessary, wherein in this case the controlling unit 730 can be omitted, or can be adapted to simply provide the received control signals to the manipulation part 713 and/or readout part 714 without translation.

In particular, it is preferred that the controlling unit 730 is configured to provide the control signals that control the manipulation part 713 such that the manipulation part 713 manipulates the second portion operation part 711 such that the states of the quantum elements are manipulated based on operations that are related to the second portion of the problem. Moreover, the control unit 730 is preferably configured to provide the control signals that control the manipulation part 713 to manipulate the first portion operation part 712 such that the coupling of the bosonic fields to the quantum elements is manipulated based on operations that are related to the first portion of the problem. Thus, the controlling unit 730 is specifically adapted to control the manipulation part 713 in accordance with the principle of providing the operations with respect to the different portions of the problem to different parts of the quantum computer 710.

In the following an embodiment of apparatus 720 providing the control signals to the quantum computer 710, optionally via the controlling unit 730, will be described in more detail. The apparatus 720 comprises a problem providing unit 721 that is adapted to provide a problem description that is indicative of the problem comprising the first and second portion to be solved. Preferably, the problem description refers to a quantum mechanical description of the problem, for instance, to a quantum mechanical description of an electronic-structure problem. However, the problem description can refer to any other notation of a problem that unambiguously describes the problem to be solved, wherein in this case the problem providing unit 721 can be adapted to translate the provided problem description into a quantum mechanical description that can be solved on the quantum computer 710. The problem description can be, for instance, stored in a storage unit and then provided by the problem providing unit 721 or can be received by the problem providing unit 721, for instance, via an input unit into which a user provides an input of the problem description. Thus, in a preferred embodiment, the problem providing unit 721 refers to a user interface allowing a user to define the problem to be solved such that a problem description can be provided to the trial state determination unit 722.

The trial state determination unit 722 is then adapted to determine a trial state representation for the problem description based on a variational approach. Preferably, the trial state determination unit is adapted to utilize a variational Hamiltonian ansatz or a unitary coupled cluster ansatz for determining the trial state representation. The trial state representation generally comprises one or more variational parameters, wherein the trial state representation is optimizable with respect to the variational parameters. In particular, the trial state representation is determined such that for at least one optimal value of the respective one or more variational parameters the trial state representation is in an optimal state, i.e. at least one observable of the trial state representation is in a minimum or a maximum state. Moreover, the trial state representation is determined such that the at least one observable referring to the optimized state of the trial state representation is indicative of the solution of the problem that should be solved. According to the principles of the invention, the trial state determination unit is adapted to determine the trial state representation such that it also comprises parts that refer to the first and second portion of the problem, i.e. such that the trial state representation comprises a first part referring to or being translatable to fermion-boson interactions or spin-boson interactions and a second part referring to or being translatable to non-interacting fermions or non-interacting spins, respectively. Thus, also the trial state representation still comprises a problem structure that is similar to the structure of the original problem. The trial state determination unit 722 then provides the determined trial state representation to the translation unit 723.

A translation unit 723 is generally adapted to translate the trial state representation for specific values of the one or more variational parameters into an operation trial state description. The operation trial state description comprises a sequence of quantum operations to be applied to the quantum representation elements 711, 712 of the quantum computer 710 to prepare a representation of the trial state representation, i.e. the trial state, on the quantum computer 710. For example, the quantum operations can refer to quantum gates applied to the quantum elements forming the qubits of the quantum computer 710 and/or to boson operations applied on the coupling between bosonic fields and quantum elements or to the bosonic fields representations themselves. In particular, the sequence of operations comprises a) second operations determined based on the second part of the trial state representation and b) first operations determined based on the first part of the trial state representation. Thus, also during the translation of the trial state representation into quantum operations the principle of splitting the problem into two portions that are processed differently is maintained. The operation trial state description comprising the sequence of quantum operations is then provided by the translation unit 723 to the control signal providing unit 724.

The controlling signal providing unit 724 is adapted for providing control signals for controlling the application of the determined sequence of quantum operations to the quantum computer 710, optionally, via controlling unit 730. For example, the controlling unit 730 can be utilized for translating the control signals provided by the controlling signal providing unit 724 into a format that is interpretable by the quantum computer 710, for instance, by the manipulation part 713. However, the controlling signal providing unit 724 can also be adapted to provide the control signals already in a format that can be directly utilized with the quantum computer 710, wherein in this case the controlling unit 730 can be omitted. The control signals provided by the controlling signal providing unit 724 are generally provided such that the control signals referring to the first operations and control signals referring to the second operations are performed by different parts of the quantum computer. For example, if the quantum computer refers to a generally known quantum computer, the control signals referring to the first operations can be performed with respect to a predetermined set of quantum elements forming qubits and the control signals referring to the second operations can be performed with respect to a different set of quantum elements forming qubits. However, it is preferred that the quantum computer refers to a quantum computer that is specifically modified for providing a second portion operation part 711 and a first portion operation part 712 as described above. In this case, the control signals referring to the first operations can be provided to the manipulation unit 713 such that the first operations are applied to the first portion operation part 712 and the second operations are applied to the second portion operation part 711. This allows to prepare the respective states of the trial state representation on hardware dedicated for these respective parts of the trial state representation such that an easier control and an even higher accuracy can be reached.

Optionally, in a preferred embodiment, the apparatus 720 further comprises an iteration controlling unit 725 that is adapted for controlling an iteration utilized for optimizing the trial state representation in order to determine an optimized observable for the trial state representation. In particular, the iteration controlling unit 725 can be adapted to determine the values of the variational parameters in each iteration step. For example, first predetermined initial variational parameters can be utilized for the first iteration and then for all following iteration steps the variational parameters can be adapted, for example, following known algorithms based on the variational parameters and the at least one measured observable of the previous iteration step. During each iteration step, the iteration controlling unit 725 can be adapted to control, for instance, the translation unit 723 to translate the trial state representation for the specific values of the current iteration step of the variational parameters and further to control the controlling signal providing unit 724 to again provide the control signals that allow the preparation of the trial state representation for the specific values of the variational parameters of the current iteration step. Further, the iteration controlling unit 725 can be adapted to control the controlling signal providing unit 724 to provide the control signals for the readout of the respective at least one observable after the preparation of the trial state representation on the quantum computer and to further determine if a respective abortion criterion with respect to the measured at least one observable is reached, for instance, if the measured at least one observable has already converged or if, for instance, a predetermined maximum number of iteration steps is already reached. If none of these abortion criteria is fulfilled, the iteration controlling unit 725 is adapted to again adapt the variational parameters and start a new iteration step with new determined variational parameters. However, if it is determined that the at least one observable has converged, for instance, that the difference between the currently measured observable and an observable measured in the previous step lies below a predetermined convergence criterion, then the iteration controlling unit 725 can be adapted to determine that the observable measured for the last iteration step refers to the at least one final observable.

The at least one final observable can then be provided by the iteration controlling unit 725 to the, also optional, result determination unit 726 that can then be adapted to determine from the at least one final observable the solution for the problem. For example, if the problem refers to determining the energy of a ground state of an electronic-structure system, the at least one observable can refer to an energy of the prepared trial state representation on the quantum computer and thus the optimized energy can directly refer to the solution of the problem, i.e. the energy of the ground state of the electronic-structure system. However, the result determination unit can also be adapted to further process the at least one final observable for determining the solution for the problem, for instance, to translate the at least one final observable again into the formalism of the respectively provided problem description or to utilize the at least one final observable in further algorithms for determining the solution for the problem.

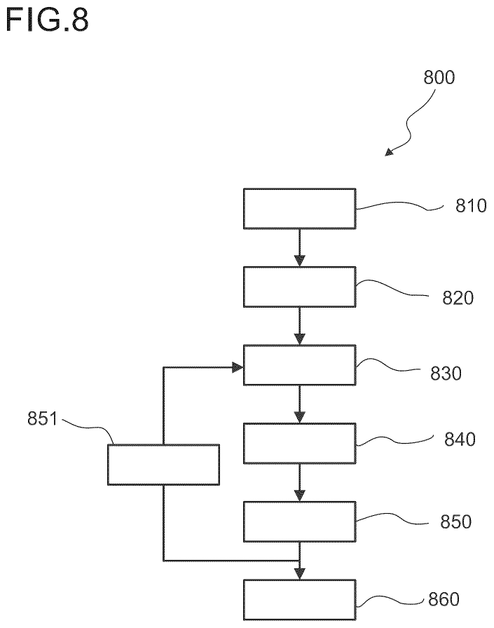

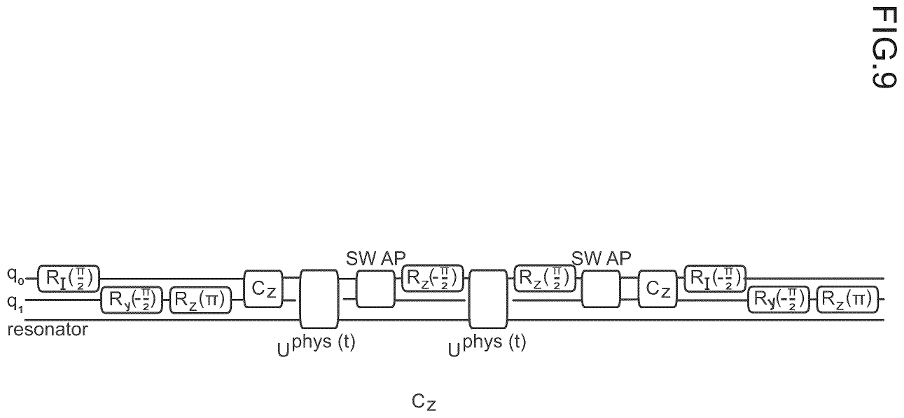

FIG. 8 shows schematically and exemplarily a flow chart of a method 800 for determining control signals for generating a solution of a problem, as already described above. The method comprises in a first step 810 providing a problem description indicative of the problem to be solved. In particular, as described in more detail above, the problem description comprises a first portion translatable into a quantum mechanical description referring to a fermion-boson interaction or spin-boson interaction and a second portion translatable into a quantum mechanical description referring to non-interacting fermions or non-interacting spins, respectively. In a further step 820, a trial state representation of the problem description is determined based on a variational approach in accordance with the principles already described above with respect to the trial state determination unit 722. After the determination of the trial state representation in step 820, in step 830 the trial state representation is translated for specific values of the one or more variational parameters into an operation trial state description comprising a sequence of quantum operations. In particular, the sequence of quantum operations comprises, as already described above, for instance, with respect to the translation unit 723, first and second operations, wherein the first operations are determined based on the parts of the trial state representation which refer to fermion-boson or spin-boson interactions and wherein the second operations are determined based on the parts of the trial state representation which refer to non-interacting fermions or non-interacting spins, respectively. In step 840 the control signals for controlling the application of the determined sequence of quantum operations are provided to the quantum computer. In particular, the control signals are provided such that the first operations and the second operations are provided to different parts of the quantum computer, preferably, to a first portion operation part and a second portion operation part, respectively. In step 850 the control signals for reading out the quantum computer are then provided to the quantum computer to measure, after the application of the sequence of determined quantum operations, i.e. after the preparation of the trial state representation on the quantum computer, at least one observable of the quantum mechanical state of the prepared representation of the trial state representation.

In a preferred embodiment, the method 800 further comprises an iteration of the trial state representation for optimizing the at least one observable of the trial state representation, wherein the iteration is represented in FIG. 8 by an arrow and step 851. In particular, after the measurement of the at least one observable in step 850, in step 851 it can be determined whether a predetermined convergence criterion is already fulfilled, for instance, if the at least one readout observable has already converged or whether a failure criterion is fulfilled. If this is not the case, the method 800 can comprise to determine in step 851 new values for the one or more variational parameters to be utilized in the next iteration step. Then, the steps 830, 840 and 850 are again performed with the newly determined specific values for the one or more variational parameters. This iteration 851 is then performed until indeed it is determined after step 850 that the convergence criterion is fulfilled, in particular, until it is determined that the at least one observable has converged. In this case the last at least one measured observable can be determined as the at least one final observable. The at least one final observable is then optionally utilized in step 860 for determining a solution of the problem.

In the following a more detailed example of an embodiment of the invention will be described with respect to a specific problem. In this example the problem is translatable into a quantum mechanical description comprising fermion-fermion interactions. For example, molecules and solids can be described accordingly. Preferably, for such a problem the apparatus further comprises a transformation unit adapted to transform the problem description into a problem description being representable by a quantum mechanical description comprising boson-fermion interactions and non-interacting fermions. Such coupled fermion-boson systems can be simulated on existing quantum computing architectures more easily, in some cases even more advantageously if the quantum computational hardware is adapted accordingly, as also described below. In particular, the required number of quantum gate operations can be reduced from [symbol] (N⁴) to [symbol] (N²), where N is a measure for the problem size, e.g. number of orbitals or system size. This reduces the computation time and computational complexity and potentially allows for the simulation of larger systems than currently expected to be possible on near-term quantum computers. Furthermore, simulating physical fermion-boson interactions such as electron-photon and electron-phonon interactions is important for understanding phenomena such as UV/Vis spectra or vibronic transitions in molecules, as well as transport phenomena in solids or for the engineering of, optionally, quantum, sensors. For solving problems in this context it is often sensible to prepare the ground state of a fermion-boson Hamiltonian of the form on a quantum computer:

$${H}_{fermion - boson} = {\sum }_{i j} {h}_{i j} {c}_{i}^{†} {c}_{j} + {\sum }_{i j k l} {U}_{i j k l} {c}_{i}^{†} {c}_{j} {c}_{k}^{†} {c}_{l} + {\sum }_{i j r} {g}_{ij , r} {c}_{i}^{†} {c}_{j} ( {b}_{r} + {b}_{r}^{†} ) + {\sum }_{r} {ω}_{r} {b}_{r}^{†} {b}_{r}$$

The

$${c}_{i}^{†}$$

operator is the creation for a fermion in state i, which adds a fermion to that state, and cᵢ the annihilation operator removing a fermion from state i. hᵢⱼ describes non-interacting fermions moving in external potentials, from, e.g., nuclei or electromagnetic fields, wherein the external potentials can be time-dependent, e.g., for an oscillating electromagnetic field, or static. Uᵢⱼₖₗ describes a general fermion interaction, e.g., Coulomb repulsion for electrons. The operator bᵣ is a bosonic annihilation operator removing one boson from mode r and

$${b}_{r}^{†}$$

is a creation operator adding a bosonic excitation to mode r. g_{ij,r} describes the coupling strength between bosonic mode r and fermion states i and j. The ωᵣ are eigenfrequencies of the bosonic modes.

For the example of superconducting quantum computing hardware the bosonic modes, i.e. bosonic fields, can, e.g., be represented by additional hardware resonators while the fermionic modes remain to be represented by the existent quantum elements forming the qubits, for example, in a quantum register as described above. However, in particular, when utilizing such a quantum computer hardware for solving the above problem, in generally known approaches, this leads to two different time scales that must be matched up during the calculation, namely the simulated time evolution of the qubits and the real, physical time evolution of the resonators. Additionally, it can be challenging to find a respective quantum computer that comprises resonators of the desired frequencies for the specific problem, as, in most cases, the frequencies of the resonators are fixed within certain thresholds given by the respective hardware setup. Both problems do not exist in standard qubit-only fermionic simulations. The present invention, as described above, for instance with respect to the apparatus allows to solve these problems when utilizing superconducting quantum computers and trying to solve problems on specific hardware with bosonic field coupling. However, the invention has also other advantages, as already described above.

In the following the quantum mechanical hardware preferably used together with the above described apparatus for performing the quantum mechanical calculations, for example, the preparation of the trial state representation, is described in more detail.

In a first preferred embodiment, the utilized quantum computer refers to a superconducting quantum computer. In this case, the bosonic modes, i.e. bosonic fields, can be represented by, preferably, providing additional hardware resonators as boson elements, e.g. LC circuits, since, e.g., read-out resonators cannot be used for both readout and representation of bosonic modes. It is then preferred that [symbol] (N) additional resonators are arranged on a chip comprising the superconducting circuits forming the qubits. In particular, it is preferred that two to four additional resonators are provided per qubit, i.e. quantum element, and arranged such that they can be coupled to the respective qubit. For example, if the translation unit is adapted to apply a constrained random phase approximation to a quantum mechanical description of the problem, one resulting frequency-dependent interaction portion can be translated to quantum operations that are to be applied on two to four hardware resonators. In another example, in a case in which the quantum mechanical description of the problem comprises a 4-index interaction term as present in a molecular Hamiltonian, [symbol] (N²) additional resonators are preferably provided. Since this amount of resonators can be difficult to arrange in one chip, it is preferred that the translation unit is adapted to apply a low-rank decomposition on the quantum mechanical description of the problem in order to reduce the requirement to [symbol] (N) or [symbol] (N log N) resonators.

It can in some hardware realizations be challenging to provide resonators comprising a desired frequency for a specific problem since frequencies of resonators are often fixed within certain thresholds due to the fixed resonator length and the superconducting gap. In particular, if the quantum mechanical description of the problem comprises static fermion interactions high frequencies have to be provided by the resonators. In this case it is preferred that the translation unit of the apparatus is adapted to translate the quantum mechanical problem description into a rotating reference frame of the resonator, for instance, using a rotating wave approximation. Since this approach can still lead to complicated effective time evolutions of the hardware components, in a further preferred embodiment the first portion operation part can be adapted to utilize an oscillating driving field for manipulating the coupling and/or bosonic fields. However, one advantage of utilizing the above described variational approach for solving the problem allows for most cases to circumvent these problems or at least to strongly reduce the effect of these problems. Thus, utilizing, for example, an oscillating driving field is in this approach optional.

In the following an exemplary sequence of quantum operations is discussed with respect to FIG. 9 that can be utilized when preparing a trial state representation on the quantum computer. Generally, the realization of phase quantum operations that are part of the exemplary operation sequence shown in FIG. 9 can depend on the utilized hardware. For example, in an ion-trap quantum computer, the phase quantum operations can directly refer to a manipulation of the laser light used for manipulating the coupling, in other hardware realizations the phase quantum operations can refer to modified standard quantum gates to be applied to the qubits.

Generally, it is preferred that the translation unit is adapted to utilize such phase operations for translating the first portion of the problem that refers in the quantum mechanical description to a fermion-boson interaction or spin-boson interaction to the operation description. In particular, the phase operations can refer to specifically modified standard quantum gates available on each quantum computer device hardware realization. Generally, while pure fermion-fermion interactions can be represented by standard single and two-qubit gates, the inclusion of bosonic modes leads to quantum operations that, preferably, also implement a phase depending on the state of the bosonic field, for instance, represented by an electromagnetic field in a resonator. In particular, the phase operations can refer to additional quantum gate operations followed by a waiting time during which the qubit, i.e. quantum element, and the representation of the bosonic field interact with each other in the real world.

An example for such a phase operation is described in the following referring to a modification of the known FSWAP algorithm that can be used to implement an effective time evolution of the quantum mechanical system. With respect to the boson-fermion interaction the FSWAP gates need additionally to implement the phase shift due to the bosonic modes. This is achieved, as described already above, by introducing a waiting time, i.e., the time during which the representation of the bosonic field and a respective quantum element are allowed to interact with each other, into the sequence of FSWAP gates. The unitary matrix representation of a FSWAP gate reads

$${U}^{coupling} ( t ) = ( \begin{matrix}1 & 0 & 0 & 0 \\ 0 & cos ( g ( {b}^{†} + b ) t ) & - i sin ( g ( {b}^{†} + b ) t ) & 0 \\ 0 & - i sin ( g ( {b}^{†} + b ) t ) & cos ( g ( {b}^{†} + b ) t ) & 0 \\ 0 & 0 & 0 & 1\end{matrix} )$$

where b is the bosonic annihilation operator and b^{†} the bosonic creation operator, g describes a coupling strength between a fermion or a quantum element and a bosonic mode, and t is a parameter describing the gate. An example of a corresponding gate sequence is shown in FIG. 9. Boxes on the upper two lines represent gate operations performed on two respective qubits and boxes on the third line represent operations performed on the bosonic fields or the coupling of the bosonic field to the qubits. In the boxes the respective mathematical operator to which the operation refers in the quantum mechanical description of the problem is shown. In this example a decomposition of a FSWAP gate with phase shift due to the bosonic mode into Controlled-Z (CZ), SWAP gates, single-qubit gates and a boson gate denoted U^{phys} is shown. The boson gate taking into account the phase shift can in this case also be regarded as a phase operation and refers to a waiting time in which the interaction between the qubits and the bosonic fields takes place. Generally, decomposition, i.e. sequences of quantum operations, as described above can be provided for every quantum computer hardware realization accordingly. Measuring, i.e. reading out, the Hamiltonian and other observables of the quantum mechanical system also preferably comprises a measurement of the bosonic field, for instance, of one or more observables of an electromagnetic field generated by the resonators. It is thus preferred that the readout part is adapted accordingly. Since qubit and boson operators commute, the readout part can be adapted to measure the observables of the quantum elements and the observables of the bosonic field simultaneously or sequentially. In the following processing of the measurement results a standard Hamiltonian averaging for the measurement can be used.

Preferably, the coupling between the quantum elements and the resonators is configured to be digitally switchable and tuneable. In particular, the first portion operation part can allow for a manipulation of the coupling strength. However, generally the coupling can be physically restricted, e.g. for Transmon qubits transversal coupling can be stronger than a longitudinal coupling, whereas for flux qubits the transversal and longitudinal coupling can be equally strong. Moreover, the coupling energy can physically be limited to approximately 10% of the qubit level splitting energy for Transmons. Preferably, a coupling energy of approximately 1% is used for the coupling.

When utilizing resonators to represent the bosonic fields two different time scales have to be synchronized during the quantum mechanical calculation. In particular, the simulated, for example, Trotterized time evolution of the qubits and the real, i.e. physical, time evolution of the resonators have to be synchronized. Utilizing the variational approach of the present invention allows to omit additional synchronization methods, due to the nature of this approach. However, in some cases it can be advantageous to utilize additional synchronization methods. Preferably, the translation unit is adapted to translate the quantum mechanical description of the problem into quantum operations such that the simulated time is smaller or equal than the real time and by utilizing a waiting operation referring to a waiting time. During the waiting time operation no further operations are applied and the bosonic fields are allowed to interact with the quantum elements.

An advantage of the superconducting quantum computer as described above is that generally quantum operations and, in particular, quantum gates can be applied in parallel. This allows also the translation unit to take this parallelism into account when generating the sequence of quantum operations, for instance, by determining quantum operations of the sequence that can be applied at the same time. A further advantage is that the resonators allow to apply a broadening of bosonic peaks, e.g. via external fields or coupling of bosonic fields to ancilla qubits that can be measured to increase broadening. Further, it is also advantageously possible to measure the bosonic fields directly, for instance, by measuring characteristics of the field generated by each of the resonators. A further advantage of this hardware, in particular, with respect to the approach used by the above described apparatus according to the invention is, that superconducting quantum computers allow to directly measure the term [symbol] b^{†}+b [symbol] as quantum mechanical observable. In particular, when solving problems with respect to determining a ground or an excitation state of a quantum mechanical system, e.g., a quantum mechanical many-body system, electrons in atoms or molecules, spins in solids, etc., this allows for a technically simpler realization of the readout of the respective observable.

In a further preferred embodiment the quantum computer utilized refers to a trapped ion quantum hardware. In particular, in this case the vibrational modes of the trapped ions can be used to represent bosonic modes, i.e. the bosonic fields. In this embodiment no hardware boson elements have to be provided for the representation of the bosonic fields. Instead the first portion operation part can be configured such that the already present vibration modes of the trapped ions can be manipulated to interact, i.e. couple, to the electronic states of the trapped ions forming the qubits. Since the bosonic fields in this case are represented by the vibrational modes, the number of bosonic modes is naturally limited by the number of ions leading to approximately 3N bosonic fields.

Generally, it is preferred that the first portion operation part allows for a manipulation of frequencies of the bosonic fields for providing energy to respective vibrational modes, to transfer energy from a vibrational mode to an electronic mode of a trapped ion or to transfer energy from an electronic mode to a vibrational mode. In case of a trapped ion quantum computer, the manipulation of the frequencies of the bosonic fields can be realized by manipulating the distance between trapped ions, for instance, by manipulating the electromagnetic fields trapping the ions in the ion trap, by manipulating the frequency of the laser that is used for manipulating the quantum elements or by utilizing a rotating frame. This allows to manipulate the coupling and/or the bosonic fields themselves very easily. Also in this case the translation unit can be adapted to additionally translate the quantum mechanical problem description into a rotating reference frame, wherein the rotating reference frame can be chosen more flexible due to the possibility of utilizing lasers for manipulating the vibrational modes. Moreover, it is preferred that the translation unit is adapted to provide an operation description of the problem comprising quantum operations that tune the laser to be in resonance with the frequencies of the fermionic and/or bosonic modes such that complicated time evolution effects are suppressed. Generally, in contrast to the above described realization of the superconducting quantum computer, in the ion trap realization the time scales of the time evolution of the qubits and the time evolution of the bosonic fields are identical, since both are realized by the same quantum mechanical system of trapped ions.

In contrast to superconducting hardware the coupling of the bosonic fields to the quantum elements can be regarded as being naturally implemented through the possibility of transferring energy from the vibrational modes to and/or from electronic states of the trapped ions. The first portion operation part is thus preferably configured to allow for this coupling by controlling the coupling via laser pulses.

In an ion trap quantum computer quantum gates can generally only be applied in a serialized way. Thus, it is preferred that for this embodiment the translation unit is adapted to take this into account by providing the operation description such that the respective sequence of quantum operations only refers to quantum operations that are applied in a serial manner. However, if solutions are found that allow a parallel application of quantum operations on ion trap quantum computers, the translation unit can also take these new solutions into account.

Also in this case the translation unit can be adapted to utilize also quantum operations that lead to a broadening of bosonic peaks. Such quantum operations can refer, for instance, to a coupling of an external field to the bosonic fields or by utilizing ancilla qubits that can be measured to increase broadening.

Preferably, the translation unit is for this case adapted to apply a constrained random phase approximation to a quantum mechanical description of the problem, in particular, deriving effective electron-electron interactions. For such interactions provided by the problem, the above described hardware is particularly useful.

In a further preferred embodiment, instead of implementing the bosonic degrees of freedom as superconducting resonator lines or using vibrational modes in trapped ion hardware, they can also be implemented using specifically determined qubit gates on quantum elements. In this case the first portion operation part is adapted to utilize an overhead in the number of quantum elements forming qubits to represent the bosonic fields and the coupling between the bosonic fields and the quantum elements representing the other quantities of the problem. Thus, in this embodiment it is preferred that the manipulation unit provides specific quantum operations for encoding the coupling and the bosonic fields in the overhead qubits. In this case it is preferred that the manipulation unit defines a cutoff threshold for the number of qubits that can be utilized for representing the bosonic fields, and thus provides a limit to the number of excitations in a bosonic mode that can be simulated. The threshold can be defined by utilizing a phenomenological approach.

Although in this embodiment the bosonic coupling is implemented also using quantum elements forming qubits, the sequence of quantum operations for a given problem does not necessarily also comprise substantially more quantum operations as in any of the above implementations, since the bosonic fields themselves do not interact and the time evolution can be applied in parallel to all bosonic fields as well as in parallel to the fermionic quantum elements. Moreover, the overhead quantum elements are preferably provided with less interaction possibilities than provided by the quantum elements dedicated for representing the non-interacting fermions. This has the advantage that this embodiment allows for an improved controllability at low excitation levels of bosonic modes.

Moreover, also other quantum computer architectures can be modified to allow for representing the bosonic fields and providing a first portion operation part that allows for the implementation of a coupling between the bosonic fields and the quantum elements. For example, ultracold/Rydberg atom quantum hardware architectures, can also be utilized and modified in accordance with the above described principles.

In the following an example of solving a problem according to the invention, will be described with respect to utilizing a superconducting quantum computer with additional digitally switchable resonators for representing the bosonic fields. Such resonators provide more flexibility and are readily available for implementation in the hardware of the quantum computer. However, the described general principles can also be applied to any of the above described further quantum computer realizations. The following function can, for instance, be performed by respective units of the apparatus in order to provide the respective control signals related to quantum operations solving the problem on the quantum computer.

A main principle of the invention for solving, for instance, the above-mentioned problems when utilizing superconducting quantum computers, refers to the utilization of variational approaches. In particular, these approaches allow to prepare a good approximation of a ground state of a coupled fermion-boson system on a quantum computer. These approaches are generally more limited in the application to specific problems than directly simulating the unitary time evolution of a fermionic system with the help of bosonic resonators via

$$U = exp ( - i {H}_{f e r m i o n - b o s o n} t )$$

but have also less strict requirements on the quantum mechanical hardware, e.g., the two different time scales mentioned above do not necessarily need to match up.

An advantage of utilizing the variational approach is that only the preparation of the trial state representation has to be implemented on a quantum computer as a function of a set of variational parameters, instead of preparing the full time resolved simulation of the problem. Preferably, the trial state determination unit is adapted to utilize, for the determination of trial state representation, a Variational Hamiltonian Ansatz (VHA). In this case the preparation, i.e. the application of the sequence of quantum operations, involves applying the partial time evolution of the original problem to an initial state. However, the trial state representation preparation does not need to have any connection to a physical time evolution. Thus, the problems with the full, physical time evolution as described above can be circumvented.

Generally, in this example the aim of using the variational approach, as described with respect to the apparatus above, in particular, for a fermion-boson quantum mechanical description, is to prepare a set of correlated qubit-resonator states on the quantum computer, where the qubits represent the fermionic degrees of freedom of the problem and the resonators the bosonic degrees of freedom, then measure the energy of the simulated state represented by the qubit-resonator state and minimize the energy over the variational parameters of the trial states. However, in other examples, other hardware elements than the resonators can be used for representing the bosonic degrees of freedom, even additional qubits, while not deviating from the respective principle of preparing the representation of the trial state representation on different parts of the quantum computer. Moreover, in other examples, also other observables can be chosen for optimization than the energy of the prepared trial state representation, depending on the respective problem.

Since in this principle the prepared representation of the trial state representation is only measured at one point in time, generally the physical properties of the bosonic field representations, e.g. the resonators, do not need to exactly correspond to the properties of the simulated bosonic modes, just like the energy splitting of the qubits does generally not correspond to the onsite-energy of the fermionic model.

Preferably, the trial state determination unit is adapted, when determining the trial state representation, to utilize a frequency for the bosonic field representation, e.g. the physical resonators, that is convenient for the respective implementation of the bosonic fields. Moreover, it is preferred that the variational parameters are chosen such that the time evolution of the first and second part of the trial state representation is implemented by different times that can be used as variational parameters. For example, preferably tₕₒₚ, tᵢₙₜ, t_{coupl}, T_{wait} referring to a fermionic hopping, a fermionic interaction, a fermion-boson coupling and a wait time, respectively, are chosen by the trial state representation unit as variational parameters. This can lead for the above Hamiltonian example to the following unitary evolution operator in a quantum mechanical description of:

$$U ( {t}_{hop} , {t}_{i n t} , {t}_{coupl} , {τ}_{w a i t} ) = {\prod }_{s = 1}^{{n}_{layer}} \{ exp ( - i {t}_{hop} ( s ) {\sum }_{i j} {h}_{i j} {c}_{i}^{†} {c}_{j} + h . c . ) exp ( - i {τ}_{h o p} ( s ) {\sum }_{r} {Ω}_{r} {b}_{r}^{†} {b}_{r} ) \times exp ( - i {t}_{i n t} ( s ) {\sum }_{i j k l} {U}_{i j k l} {c}_{i}^{†} {c}_{j} {c}_{k}^{†} {c}_{l} ) exp ( - i {τ}_{i n t} ( s ) {\sum }_{r} {Ω}_{r} {b}_{r}^{†} {b}_{r} ) \times exp ( - i {t}_{coupl} ( s ) {\sum }_{i j r} {g}_{ij , r} {c}_{i}^{†} {c}_{j} ( {b}_{r} + {b}_{r}^{†} ) + h . c . ) exp ( - i {τ}_{coupl} ( s ) {\sum }_{r} {Ω}_{r} {b}_{r}^{†} {b}_{r} ) \times exp ( - i {τ}_{w a i t} ( s ) {\sum }_{r} {Ω}_{r} {b}_{r}^{†} {b}_{r} ) \}$$

Preferably, the controlling signal providing unit is adapted to provide control signals for controlling the quantum computer to prepare a predetermined initial state representation on the quantum representation elements of the quantum computer. The unitary evolution operator U can then be translated into a sequence of operations to prepare the representation of the trial state representation on the quantum computer. For example, the above time evolution can then be applied to an initial state representation as defined by the trial state representation:

$${{\vert {ψ}_{trial} 〉 = U ( {t}_{hop} , {t}_{int} , {t}_{coupl} , {τ}_{wait} ) \vert {ψ}_{0} 〉}_{fermions} ⊗ \vert 00000 … 〉}_{b o s o n s}$$

Ωᵣ are the physical bosonic frequencies, e.g., the physical resonator frequencies, |ψ₀ [symbol] _{fermions} is a fermionic initial state, e.g., a Hartree-Fock reference state and |00000 . . . [symbol] _{bosons} the collective bosonic initial state, that can be the ground state. In some embodiments the trial state determination unit can be adapted to replace the four-index fermionic interaction Uᵢⱼₖₗ by a density-density fermionic interaction, e.g. by applying a low-rank decomposition. An example for such a low-rank decomposition can be found, for instance, in the article “Low rank representations for quantum simulation of electronic structure”, M. Motta, et. al., npj Quantum Inf 7, 83 (2021). Alternatively, in some examples, for instance, depending on the problem, the trial state representation unit can be adapted to apply a Fermi-Hubbard model in order to reduce the complexity. In both cases

$$exp ( - i {t}_{i n t} ( s ) {Σ}_{i j k l} {U}_{i j k l} {c}_{i}^{†} {c}_{j} {c}_{k}^{†} {c}_{l} )$$

is replacedd by

$$exp ( - i {t}_{i n t} ( s ) {Σ}_{k j} {U}_{k j} ( {n}_{k} - \frac{1}{2} ) ( {n}_{j} - \frac{1}{2} ) ) ,$$

where nⱼ is the particle-number operator for the fermionic state j. This modification can also be directly applied to the quantum mechanical description of the problem, for example, to the above described Hamiltonian, or can be applied to the trial state representation directly, for instance, to the above described equation.

In the above equation it is distinguished between simulated times using small Latin t and simulation times, i.e., time elapsing in the laboratory, using τ, τᵢₙₜ, τ_{coupl} and τₕₒₚ are the times utilized to implement the corresponding fermionic terms on the quantum computer while τ_{wait} can be used as an additional variational parameter. The simulated times t can be used as variational parameters. To increase the accuracy the number of layers n_{layer} can be increased to use a larger number of variational parameters τ(s) and t(s).

The above described example leads to a trial state representation for which the expectation values of

$${c}_{i}^{†} {c}_{j} + h . c . , {c}_{i}^{†} {c}_{j} {c}_{k}^{†} {c}_{l} or {n}_{k} {n}_{j} , {c}_{i}^{†} {c}_{j} ( {b}_{r} + {b}_{r}^{†} ) + h . c . , {b}_{r}^{†} {b}_{r}$$

are measured as observables. The expectation value of the Hamiltonian, i.e. the energy of the trial state representation, as the cost function of the variational optimization, is then reconstructed from the measured expectation values using the chosen bosonic frequencies or and not the physical frequencies Ωᵣ. In this specific example, of the variational approach the utilized hardware of the quantum computer has to allow for a measurement of the excitation level

$$〈 {b}_{r}^{†} {b}_{r} 〉$$

of the resonators.

Generally following the above described principles, instead of a problem being translatable into a quantum mechanical description comprising fermion-boson interactions, also a problem being translatable into a quantum mechanical description comprising spin-boson interactions can be processed, for example, by replacing all fermionic operators above by spin operators, e.g. Pauli matrices.

In the following a more detailed example of a method for processing a problem as described above will be provided. The method can be performed by respective units of the apparatus, for example, as described with respect to FIG. 7.

In a first step of the method, performed, for example, by the problem providing unit, a respective problem is provided that is translatable into a quantum mechanical description comprising first and second parts, for example, as described above in more detail. Generally, this step is performed on a classical computer. For example, the problem description can refer to the Hamiltonian H_{fermion-boson} discussed above. In a next step performed, for instance, by the trial state determination unit, the trial state representation of the problem is determined, for example, as discussed above, by determining the unitary evolution operator U(tₕₒₚ, tᵢₙₜ, t_{coupl}, τ_{wait}) that applied to an initial state leads to the trial state representation. Further, in this step utilizing, for example, also the trial state determination unit and/or the translation unit, the sequence of quantum operations for preparing an initial state representation, in particular, a fermionic initial state |ψ₀ [symbol] _{fermions}, can be determined. Moreover, also quantities present in the trial state representation, in particular, in the operator U, like the coupling strength g_{ij,r} and the integrals hᵢⱼ and Uᵢⱼₖₗ can be determined on a classical computer, e.g. by using a Hartree-Fock calculation, in this step. Moreover, in a next step the translation unit can be adapted to determine the sequence of quantum operations leading to the trial state representation, for example, by encoding the fermionic operators in U(tₕₒₚ, tᵢₙₜ, t_{coupl}, τ_{wait}), using preferably a Jordan-Wigner or Bravyi-Kitaev transformation. For this step the iteration controlling unit can be adapted to choose initial values for the variational parameters, for instance, for the different time parameters t and τ_{wait}.

In the next step the sequence of operations referring to the trial state representation operation description are translated into control signals send, for example, by the controlling signal providing unit, to the quantum computer such that first the qubit register, i.e. the quantum elements, are initialized according to |ψ₀ [symbol] fermions and the bosonic modes are initialized in the initial state representation, for example, as |00000 . . . [symbol] _{bosons}, on the quantum computer. Secondly the control signals that are based on the sequence of operations are provided such that the trial state representation is prepared on the quantum computer, for example, by applying a sequence representing the unitary operator U to create an entangled fermion-boson trial state representation |ψₜᵣᵢₐₗ [symbol] according to the above trial state representation example. In some embodiments, previous to the preparation, a FSIM network algorithm using low-rank decomposition or a CZ algorithm can be used to determine the respective trial state representation.

Then the respective observables for which the trial state representation is optimized are measured. For example, for the exemplary problem above the energy of the prepared trial state representation is measured with respect to the Hamiltonian, E= [symbol] ψₜᵣᵢₐₗ|H_{fermion-boson}|ψₜᵣᵢₐₗ [symbol] , on the quantum computer. For this the expectation values of

$${c}_{i}^{†} {c}_{j} + h . c . , {c}_{i}^{†} {c}_{j} {c}_{k}^{†} {c}_{l} ( or {n}_{k} {n}_{j} ) , {c}_{i}^{†} {c}_{j} ( {b}_{r} + {b}_{r}^{†} ) + h . c . , and {b}_{r}^{†} {b}_{r}$$

are measured utilizing, for instance stance, the readout unit. The iteration controlling unit can then be adapted to determine the expectation value of H_{fermion-boson} from the measured expectation values using the model bosonic frequencies ωᵣ and not the physical frequencies Ωᵣ. Generally, if the observable, e.g. the energy E, is not yet converged, the iteration controlling unit can be adapted to adjust all variational parameters, e.g. t and τ_{wait} on the classical computer in order to optimize the observable, e.g. minimize the energy, and start the next iteration step by starting the repeating part of the iteration by determining the quantum operation sequence for the new variational parameters. For example, new variational parameters can be determined utilizing COBYLA, L-BFGS, or CG optimization methods. If an observable has converged with respect to a predetermined convergence criterion a final observable, e.g. a final energy E, is determined and used, for example, by the result determination unit for determining the solution of the problem, for example, as ingredient for further post-processing on the classical computer and applications to the respective specific molecules, solids, materials, etc.

Generally, the above described invention, for example, the apparatus and method, can be applied to a plurality of problems. Preferred applications will be described in the following. For example, the method can be used to simulate physical fermion-boson systems. One example, refers to the simulation of electronic-structure systems, including both molecular and condensed-matter systems that interact with bosons. Also electron-phonon systems, e.g. vibronic absorption and emission spectra, for calculating Franck-Condon factors, IR spectra, etc. and electron-vibration coupling in molecules, polarons in condensed-matter systems can be solved. Further, problems in the field of electron-photon systems, e.g. interaction of molecules with electromagnetic fields leading to electronic transitions relevant for UV/Vis spectroscopy, e.g. absorption, emission such as fluorescence and phosphorescence, photoelectron spectroscopy, can be processed. Moreover, the invention allows to process electron-exciton systems, electron-phonon coupling in metals, semi-conductors, thermoelectrics or superconductors to calculate thermal and electrical transport properties, light-matter interaction, i.e. electron-photon interaction, in, optionally quantum, sensors, and electron-spin coupling to calculate transport properties in magnetic materials e.g. Kondo effect.

Furthermore, the method and apparatus can be used to simulate physical spin-boson systems, e.g. nuclear spins or electron spins interacting with photons, relevant for NMR and ESR. With respect to physical fermion-boson systems, the application is not limited to systems where the fermions are electrons but can also be used to simulate other physical fermion-boson systems, including such where fermions are other elementary particles, e.g. muons, neutrinos, quarks, or composite particles, e.g. protons and neutrons, and bosons are gauge bosons, e.g. photons, W and Z bosons, gluons, or quasiparticles, e.g. magnons, plasmons.

Furthermore, the method can also be used to simulate coupled fermion-boson systems that are obtained by a Hubbard-Stratonovich transformation of a purely fermionic system. Coupled fermion-boson systems also occur when for example calculating electron screening to provide an effective frequency-dependent interaction of electrons that are not part of an active space calculation. Preferably, for such systems a constrained random phase approximation (cRPA) can be utilized.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the problem, the translating of the problem, the generating of the control signals, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or specialpurpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

1. An apparatus for determining control signals for generating a solution of a problem translatable into a quantum mechanical description using a quantum computer, wherein the apparatus comprises:
a problem providing unit for providing a problem description indicative of the problem to be solved, wherein the problem description is indicative of a first portion and a second portion of the problem, wherein the first portion includes quantities describing the problem that interact with each other and the second portion includes quantities describing the problem that do not interact with each other,
a trial state determination unit for determining a trial state representation of the problem description based on a variational approach, wherein the trial state representation comprises one or more variational parameters and wherein the trial state representation comprises a first and second part representing the first and second portion of the problem, respectively,
a translation unit for translating the trial state representation for specific values of the one or more variational parameters into an operation trial state description comprising a sequence of quantum operations to be applied to quantum representation elements of the quantum computer to prepare a representation of the trial state representation on the quantum computer, wherein the sequence of operations comprises a) second operations determined based on the second part of the trial state representation and b) first operations determined based on the first part of the trial state representation, and
a controlling signal providing unit for providing control signals for controlling the application of the determined sequence of quantum operations on the quantum computer such that the representation of the trial state representation is prepared, and further for controlling a readout of the quantum computer to measure, after the application of the sequence of determined quantum operations, at least one observable of the quantum mechanical state of the prepared representation of the trial state representation, wherein the control signals are provided such that control signals referring to the first operations and control signals referring to the second operations are performed by different parts of the quantum computer.

2. The apparatus according to claim 1, wherein the apparatus further comprises an iteration controlling unit for controlling an optimization of the trial state representation utilizing an iteration of the one or more variational parameters of the trial state representation until the at least one readout observable or a quantity derivable from the at least one readout observable converges, wherein the iteration comprises adapting the one or more variational parameters of the trial state representation and repeating the translation, the providing of control signals for preparing the trial state and the providing of control signals for the readout until the at least one observable or derivable quantity has converged to at least one final observable or final derivable quantity, and wherein the apparatus further comprises a result determination unit for determining, based on the at least one final observable or final derivable quantity, the solution for the problem.

3. The apparatus according to claim 2, wherein the at least one measured observable is indicative of the energy of the prepared trial state representation, and wherein the converging of the at least one observable refers to a minimization of the energy.

4. The apparatus according to claim 1, wherein the controlling signal providing unit is adapted to provide control signals for controlling the quantum computer to prepare a predetermined initial state representation on the quantum computer before applying the determined sequence of operations to prepare the trial state representation.

5. The apparatus according to claim 4, wherein the initial state refers to a ground state of a mean-field representation of the problem or a Hartree-Fock state of the first part of the problem.

6. The apparatus according to claim 1, wherein the translating of the trial state representation for the specific variational parameters into a representative operation trial state representation is based on a Jordan-Wigner or Bravyi-Kitaev transformation.

7. The apparatus according to claim 1, wherein the problem providing unit is adapted to provide a problem description being representable as a quantum mechanical problem description comprising fermion-fermion interactions, wherein the apparatus comprises further a transformation unit adapted to transform the problem description into a problem description being representable by a quantum mechanical description comprising boson-fermion interactions as first portion of the problem and non-interacting fermions as second portion of the problem.

8. The apparatus according to claim 7, wherein, to transform the problem description into a problem description being representable as a quantum mechanical problem description comprising boson-fermion interactions and non-interacting fermions, a Hubbard Stratonovich transformation is utilized.

9. The apparatus according to claim 7, wherein the problem description comprises at least portions that are representable by a quantum mechanical description comprising a static fermion-fermion interaction as third portion of the problem and wherein the transformation unit is adapted to approximate these portions of the problem by utilizing a constrained random phase approximation.

10. The apparatus according to claim 1, wherein the variational approach refers to a variational Hamiltonian ansatz or a unitary coupled cluster ansatz.

11. A system for processing a problem, wherein the problem comprises a first portion and a second portion, wherein the first portion includes quantities describing the problem that interact with each other and the second portion includes quantities describing the problem that do not interact with each other, wherein the system comprises:
an apparatus according to claim 1 for providing control signals for controlling a quantum computer, and
a quantum computer adapted to process the provided control signals for performing the quantum mechanical calculation.

12. The system according to claim 11, wherein the quantum computer comprises:
a second portion operation part configured to utilize quantum mechanical states of quantum elements for forming qubits that are manipulable by operations performed on the quantum elements, wherein the operations are related to the second portion of the problem to be processed during the quantum computational calculation of the problem,
a first portion operation part configured to couple bosonic fields to the quantum elements, wherein the coupling of the bosonic fields to the quantum elements is manipulable by operations that are related to the first portion of the problem to be processed during the quantum computational calculation of the problem,
a manipulation part configured to manipulate a) the second portion operation part such that the states of the quantum elements are manipulated based on control signals indicative of operations that are related to the second portion of the problem to be processed during the quantum computational calculation of the problem, and b) the first portion operation part such that the coupling of the bosonic fields to the quantum elements is manipulated based on control signals indicative of operations that are related to the first portion of the problem to be processed such that a quantum mechanical calculation of the problem is performed, and
a readout part configured to measure, after the manipulation of the quantum elements and the bosonic coupling for performing the quantum mechanical calculation, at least one observable of the a) quantum mechanical state of each quantum element representing the state of a respective qubit and b) bosonic fields.

13. A computer-implemented method for determining control signals for generating a solution of a problem translatable into a quantum mechanical description using a quantum computer, wherein the method comprises:
providing a problem description indicative of the problem to be solved, wherein the problem description is indicative of a first portion and a second portion of the problem, wherein the first portion includes quantities describing the problem that interact with each other and the second portion includes quantities describing the problem that do not interact with each other,
determining a trial state representation of the problem description based on a variational approach, wherein the trial state representation comprises one or more variational parameters and wherein the trial state representation comprises a first and second part representing the first and second portion of the problem, respectively,
translating the trial state representation for specific values of the one or more variational parameters into a representative operation trial state description comprising a sequence of quantum operations to be applied to quantum representation elements of the quantum computer to prepare a representation of the trial state representation on the quantum computer, wherein the sequence of operations comprises a) second operations determined based on the second part of the trial state representation and b) first operations determined based on the first part of the trial state representation,
providing control signals for controlling the application of the determined sequence of quantum operations on the quantum computer such that the representation of the trial state representation is prepared, wherein the control signals are provided such that control signals referring to the first operations and control signals referring to the second operations are performed by different parts of the quantum computer, and
providing control signals for controlling a readout of the quantum computer to measure, after the application of the sequence of determined quantum operations, at least one observable of the quantum mechanical state of the prepared representation of the trial state representation.

14. A computer program product for solving a quantum mechanical problem, wherein the computer program product comprises program code means for causing the apparatus according to claim 1 to execute a method comprising
providing a problem description indicative of the problem to be solved, wherein the problem description is indicative of a first portion and a second portion of the problem, wherein the first portion includes quantities describing the problem that interact with each other and the second portion includes quantities describing the problem that do not interact with each other,
determining a trial state representation of the problem description based on a variational approach, wherein the trial state representation comprises one or more variational parameters and wherein the trial state representation comprises a first and second part representing the first and second portion of the problem, respectively,
translating the trial state representation for specific values of the one or more variational parameters into a representative operation trial state description comprising a sequence of quantum operations to be applied to quantum representation elements of the quantum computer to prepare a representation of the trial state representation on the quantum computer, wherein the sequence of operations comprises a) second operations determined based on the second part of the trial state representation and b) first operations determined based on the first part of the trial state representation,
providing control signals for controlling the application of the determined sequence of quantum operations on the quantum computer such that the representation of the trial state representation is prepared, wherein the control signals are provided such that control signals referring to the first operations and control signals referring to the second operations are performed by different parts of the quantum computer, and
providing control signals for controlling a readout of the quantum computer to measure, after the application of the sequence of determined quantum operations, at least one observable of the quantum mechanical state of the prepared representation of the trial state representation.

15. A method for solving problems referring to electronic-structure problems, spin problems and/or optimization problems comprising using the apparatus according to claim 1.
